(19) United States
(12) Patent Application Publication
(10) Pub. No.: US 2026/0100114 A1
(43) Pub. Date: Apr. 9, 2026

(54) TICKET VENDING MACHINE SYSTEM AND METHOD

(71) Applicant: GENFARE, LLC, Elk Grove Village, IL (US)

(72) Inventors: Suraj Singh, Elk Grove Village, IL (US); Anveshan Goel, New Delhi (IN); Delbert Gray, Chicago, IL (US)

(21) Appl. No.: 19/351,150

(22) Filed: Oct. 6, 2025

Related U.S. Application Data
(60) Provisional application No. 63/703,498, filed on Oct. 4, 2024.

(51) Int. Cl. G07F 17/42; G07F 7/10; G07F 9/00; G07F 9/02

(52) U.S. Cl. CPC G07F 17/42; G07F 9/002; G07F 9/006; G07F 9/0235; G07F 9/026; G07F 7/1025; G07F 9/001; G07F 9/009

(57) ABSTRACT

Systems and methods related to a ticket vending machine are described herein. An example ticket vending machine includes a digital touch screen designed to output a user interface, the user interface designed to support at least one of an audio control, a tactile control, or combinations thereof, and a barcode reader. The ticket vending machine may also include a ticket dispenser including at least one of a smart card dispenser, a paper ticket printer, a receipt printer, or combinations thereof. The ticket vending machine may further include a fare validation system including a credit card terminal and a currency validation system, wherein the currency validation system includes a coin validation device, a currency hopper, and a bank note recycler. A housing is designed to house the digital touch screen, the barcode reader, the ticket dispenser, and the fare validation system for the ticket vending machine.

### CROSS-REFERENCE TO RELATED APPLICATIONS

This Application claims priority to U.S. Provisional Patent Application Ser. No. 63/703,498, filed on Oct. 4, 2024, entitled “TICKET VENDING MACHINE SYSTEM AND METHOD,” the entire disclosure of which is incorporated herein by reference.

### TECHNICAL FIELD

Systems and methods for a ticket vending machine (TVM) are provided. More particularly, the systems and methods are directed to a TVM within a transit network infrastructure. The TVM may be used to purchase entry authorization, e.g., a ticket, for a mode of transit, for example, a train, a bus, or other public transit system while also providing information to a user.

### BACKGROUND

Transportation agencies often position ticket vending machines (TVMs) near transit vehicle stations for transit users to purchase tickets. TVMs may receive various payment forms and methods such as coin operated machines and paper validation machines. TVMs may also collect various pieces of information including user information and transit vehicle information. In some cases, TVMs may allow a user to manually request a transit ticket. Current solutions may not allow a TVM to receive information from one or more of a network, user, and transit vehicle thus limiting the TVMs assistance in ticket purchasing and route planning.

### SUMMARY

In some aspects, the techniques described herein relate to a ticket vending machine, including a digital touch screen designed to output a user interface, the user interface designed to support at least one of an audio control, a tactile control, or combinations thereof. The ticket vending machine may also include a barcode reader, a ticket dispenser including at least one of a smart card dispenser, a paper ticket printer, or a receipt printer, or combinations thereof. The ticket vending machine may also include a fare validation system including a credit card terminal and a currency validation system, wherein the currency validation system includes a coin validation device, a currency hopper, and a bank note recycler. The ticket vending machine further includes a housing that may be designed to house the digital touch screen, the barcode reader, the ticket dispenser, and the fare validation system.

In some aspects, the techniques described herein relate to a ticket vending machine that may also include at least one memory storing processor-executable code, and at least one processor in communication with the at least one memory. The at least one processor may be individually or collectively operable to execute code to cause the ticket vending machine to receive input data associated with at least one user via the user interface and identify at least one query from the input data associated with the at least one user. The at least one processor may be individually or collectively operable to execute the code to further cause the ticket vending machine to output, to a transportation ticketing system, at least one signal indicating an information request related to the at least one query and receive, from the transportation ticketing system, at least one signal indicating information related to the information request. The at least one processor may be individually or collectively operable to execute the code to cause the ticket vending machine to also output, via the user interface, at least one signal indicating an answer to at least one query based at least in part on the information.

Within some examples, the techniques described herein relate to a ticket vending machine, wherein the fare validation system further includes a contactless payment reader.

In some aspects, the techniques described herein relate to a ticket vending machine, wherein the audio control includes at least one of a speaker, a microphone, or combinations thereof, and wherein the tactile control includes at least one of Braille markings, raised buttons, or combinations thereof.

In another example, the techniques described herein relate to a ticket vending machine, wherein the paper ticket printer is designed to print advertisements, travel information, a travel itinerary, a paid fare amount, a receipt, a travel recommendation, or combinations thereof. Within some examples, the techniques described herein relate to a ticket vending machine, wherein the receipt printer is configured to print transaction summaries, payment methods, time of purchase, or a combination thereof.

In another example, the techniques described herein relate to a ticket vending machine, including at least one communication device designed to communicate information over a network. The ticket vending machine may also include at least one memory storing processor-executable code, and at least one processor in communication with the at least one memory. The at least one processor may be individually or collectively operable to execute code to cause the ticket vending machine to receive at least one signal indicating configuration information for the ticket vending machine via the at least one communication device and update at least one configuration associated with the ticket vending machine based at least in part on the configuration information.

Within some examples, the techniques described herein relate to a ticket vending machine, wherein the configuration information is at least one of a system configuration of the ticket vending machine, a software update to the ticket vending machine, a firmware update to the ticket vending machine, a screen change for the ticket vending machine, a fare adjustment, an Internet-of-Things device associated with the ticket vending machine, a system monitoring request, or combinations thereof.

In some aspects, the techniques described herein relate to a ticket vending machine, wherein the at least one communication device includes a wireless transceiver supporting Wi-Fi communications, cellular communications, Bluetooth communications, or combinations thereof.

In some examples, the techniques described herein relate to a ticket vending machine, wherein the processor is further operable to execute code to cause the ticket vending machine to: authenticate the configuration information prior to updating the configuration, wherein the update of the at least one configuration is performed automatically upon receipt of the configuration information.

Within some examples, the techniques described herein relate to a ticket vending machine, wherein the configuration information includes at least one of a scheduled fare adjustment to be applied at a predetermined date and time, an updated user interface layout displayed on the user interface, a system maintenance update, a firmware update, a software update, advertisement information, a route update, a user account update, a user profile update, or combinations thereof.

In some aspects, the techniques described herein relate to a ticket vending machine, including a graphical user interface designed to receive passenger input related to a destination. The ticket vending machine may also include at least one memory storing processor-executable code, and at least one processor in communication with the at least one memory. The at least one processor may be individually or collectively operable to execute code to cause the ticket vending machine to determine a journey plan for a passenger to travel from an initial location to the destination over a transit network, wherein the journey plan includes two or more modes of transportation supported by the transit network. The at least one processor may be individually or collectively operable to execute code to cause the ticket vending machine to issue a multi-modal ticket for the passenger to travel to the destination according to the journey plan, wherein the multi-modal ticket includes a ticket for each of the two or more modes of transportation.

In other examples, the techniques described herein relate to a ticket vending machine, further including at least one communication device designed to communicate information over a network with at least one of the transit network, at least one transit vehicle, or combinations thereof. The at least one processor may be individually or collectively operable to execute code to cause the ticket vending machine to execute code to cause the ticket vending machine to query at least one of the transit network or the at least one transit vehicle for real-time information, wherein the real-time information includes at least one of ridership information, route information, or combinations thereof, and wherein the journey plan is further based at least in part on the real-time information.

In some aspects, the techniques described herein relate to a ticket vending machine, further including a printing device designed to print the multi-modal ticket and information related to the journey plan.

In some examples, the techniques described herein relate to a ticket vending machine, wherein the graphical user interface is further designed to display alternative journey plans and prompt a user to select a preferred journey plan from the alternative journey plans. In another example, the techniques described herein relate to a ticket vending machine, wherein a journey plan accounts for accessibility features, including step-free routes, vehicles equipped for passengers with disabilities, or a combination thereof.

Within some examples, the techniques described herein relate to a ticket vending machine, wherein the multi-modal ticket is issued in both digital and physical formats.

In some aspects, the techniques described herein relate to a ticket vending machine, wherein the processor is further operable to execute the code to cause the ticket vending machine to detect a disruption to one or more transit vehicles associated with the journey plan and update the journey plan and reissue a modified multi-modal ticket based at least in part on the disruption.

In some examples, the techniques described herein relate to a ticket vending machine, wherein the at least one communication device is further configured to receive alerts regarding service outages or disruptions from the transit network.

In some aspects, the techniques described herein relate to a ticket vending machine designed to purchase entry authorization for at least one user. The ticket vending machine including a display device designed to output a graphical user interface and at least one memory storing processor-executable code. The ticket vending machine may also include at least one processor in communication with the at least one memory. The at least one processor may be individually or collectively operable to execute code to cause the ticket vending machine to output, at the display device, a first screen according to default display settings, and output, at the display device, an interactive element that provides an option to change the default display settings. The at least one processor may be individually or collectively operable to execute the code to receive, via the interactive element, an input that indicates at least one custom display setting, and output, at the display device, a second screen according to the at least one custom display setting.

In some examples, the techniques described herein relate to a ticket vending machine, wherein the at least one processor is further operable to execute the code to cause the ticket vending machine to revise the default display settings based at least in part on the at least one custom display setting.

In other aspects, the techniques described herein relate to a ticket vending machine, wherein the at least one processor is further operable to execute the code to cause the ticket vending machine to identify a user account associated with the at least one custom display setting and store the at least one custom display setting in a user profile associated with the user account as updated default display settings. The updated default display settings include a default display setting for the user account.

In some aspects, the techniques described herein relate to a ticket vending machine, wherein the at least one processor is further operable to execute code to cause the ticket vending machine to retrieve updated default display settings from the user profile upon identification of the user account and apply the updated default display settings for the user profile.

In some aspects, the techniques described herein relate to a ticket vending machine, wherein the at least one custom display setting includes at least one accessibility feature including an increased font size, high-contrast color schemes, audio prompts, a language selection, or combinations thereof. In some aspects, the techniques described herein relate to a ticket vending machine, wherein an identification of the user account is authenticated via at least one of a smart card, a biometric input, a mobile device pairing, a personal identification number, or combinations thereof.

In some aspects, the techniques described herein relate to a ticket vending machine, wherein the at least one processor is further operable to execute the code to cause the ticket vending machine to output at least one signal indicating the updated default display settings to a remote server for synchronization with other ticket vending machines associated with the user account.

In some aspects, the techniques described herein relate to a ticket vending machine designed to purchase entry authorization for at least one user. The ticket vending machine including a display device designed to output a graphical user interface The ticket vending machine may also include at least one memory storing processor-executable code, and at least one processor in communication with the at least one memory. The at least one processor may be individually or collectively operable to execute the code to cause the ticket vending machine to receive at least one signal indicating a set of advertisements from a network and assign at least one category of a set of categories to each advertisement of the set of advertisements. The at least one processor may be individually or collectively operable to execute code to receive trip information with at least one stop, at least one passenger, or both, and assign a first category of the set of categories to the at least one stop, the at least one passenger, or both. The at least one processor may be individually or collectively operable to execute the code to select at least one advertisement of the set of advertisements based at least in part on the first category and the assignments of the at least one category to each advertisement of the set of advertisements and display the at least one advertisement on the display device.

In some aspects, the techniques described herein relate to a ticket vending machine, wherein the at least one processor is further operable to execute code to cause the ticket vending machine to update the set of advertisements in real time based at least in part on changes to the trip information or passenger profile.

Within some examples, the techniques described herein relate to a ticket vending machine, wherein the set of categories includes one of geographic location, time of day, passenger age group, passenger language preference, destination type, or combinations thereof.

In some examples, the techniques described herein relate to a ticket vending machine, wherein the at least one processor is further operable to execute code to cause the ticket vending machine to track user interactions with the displayed advertisement to determine one or more engagement metrics, and output at least one signal indicating a report of the one or more engagement metrics to an advertisement management server.

In some aspects, the techniques described herein relate to a ticket vending machine, wherein the at least one processor is further operable to execute code to cause the ticket vending machine to prioritize the selection of advertisements associated with promotions or offers relevant to the assigned first category.

### BRIEF DESCRIPTION OF THE DRAWINGS

FIG. 1 is a schematic diagram of a ticket vending machine (TVM) within a system according to a disclosed example.

FIG. 2 illustrates an example ticket vending machine for use within a system according to a disclosed example.

FIG. 3 is a block diagram of an operations module for a TVM in accordance with one or more aspects of the present disclosure.

FIG. 4 is a block diagram of a computing environment that supports the ticket vending machine as described in accordance with one or more aspects of the present disclosure.

FIG. 5 is a swimlane diagram illustrating an example system for a TVM.

FIG. 6 illustrates example user interface screens and for a ticket vending machine according to an aspect of the present disclosure.

FIG. 7 is a flowchart illustrating an example system for user customization on a TVM according to another aspect.

FIG. 8 is a flowchart illustrating an example system for dynamic advertisements on a TVM according to another example.

FIG. 9 illustrates an additional system for dynamically selecting and displaying advertisements on a ticket vending machine user interface according to an example.

FIG. 10 illustrates an example method for predictive cash management and optimization in a ticket vending machine system according to another example.

FIG. 11 illustrates an example method for a recommendation system in a transportation ticketing environment according to another aspect.

FIG. 12 illustrates an example user interface for a ticket vending machine, according to a disclosed example.

FIG. 13 illustrates an additional example user interface for a ticket vending machine.

FIG. 14 illustrates an example user interface screen for a ticket vending machine according to another aspect.

FIG. 15 illustrates an example user management interface for a ticket vending machine as disclosed within another example.

FIG. 16 illustrates an example method for a ticket vending machine system according to another aspect.

FIG. 17 illustrates an example method for a ticket vending machine system according to another an additional aspect.

FIG. 18 illustrates another example method for a ticket vending machine system.

FIG. 19 illustrates another method for a ticket vending machine system according to another example.

### DETAILED DESCRIPTION

The present disclosure relates to the use of a ticket vending machine (TVM) configured to manage, plan, customize, predict, and recommend information to the user of the TVM. The TVM described herein allows for efficient purchase management of transit tickets by a user. The TVM may communicate with a transit network to plan and tailor a travel journey to characteristics of a user or according to input from the user. The techniques and systems described herein provide accurate, prompt, and automated use of the TVM. The integration of intelligent planning and recommendation features into the TVM represents a significant advancement over traditional vending machines, supporting both individual user needs and broader transit network efficiency.

In some examples, the TVM system may include an operations module designed to receive and transmit input data for one or more users operating the TVM. The operations module may include but is not limited to a payment module, a display module, a journey module, a connectivity manager, and a prediction module. The payment module may be designed to process payments for passenger fares. Additionally, the display module may be designed to control a display of the TVM in order to provide information to the user. The journey module may be designed to develop journey plans, including multi-modal journey plans. Further, the connectivity module may support communications with other ticket vending machines, Internet-of-Things devices, a transit network, transit vehicles, and the like. In other instances, the prediction module may be designed to provide predictive analytics for revenue management at the TVM. The TVM system may also include a machine learning model for summarizing and categorizing input data efficiently and accurately based at least in part on context of input data, such as user information, fare data, or data related to a user's route, for example.

The TVM system may include at least one scanning device, which may be integrated within the TVM and on the exterior of the TVM. The at least one scanning device may include one or more of a variety of scanner types, including, but not limited to barcode scanners, Quick Response (QR) code scanners, Radio-Frequency Identification (RFID) readers, or Near-field communication (NFC) enabled devices. The system may further communicate with the operations module that may process and distribute information received from the at least one scanning device.

The TVM system may be further designed to process, store, and transmit only anonymized or aggregated transactions and usage data to protect passenger privacy and comply with applicable regulations. For example, any ticket purchase details, payment credentials, or user profile information may be encrypted, anonymized, or deleted after transaction completion or reconciliation, in accordance with agency policies and user preferences. The system may also allow users to opt in or out of data collection for personalized services or targeted advertisements, ensuring transparency and user control.

The system may generate and provide transit agencies with summarized and categorized reports detailing machine status, transaction volumes, cash and consumable levels, and user interaction analytics, organized by location, time period, or ticket type. These reports may help agencies monitor TVM performance, optimize maintenance and cash replenishment schedules, and support operational planning. Additionally, aggregated data on usage trends may be used to inform service adjustments, fare policy updates, or targeted marketing campaigns. In other examples, the system may provide real-time alerts and status updates to agency staff or maintenance crews through centralized dashboards or mobile interfaces, enabling rapid response to issues such as cash shortages, hardware faults, or security events.

The present disclosure therefore may offer a comprehensive solution for improved security, with an efficient and user-centric ticket vending machine operation and management within transit systems. By enabling agencies to reliably collect, analyze, and act on detailed data regarding machine performance, passenger transactions, user interactions, and system health, the disclosed systems and methods support improved operational efficiency, enhanced passenger experience, customized user interaction, and increased informed decision-making. Additionally, these techniques may contribute to increased revenue protection, streamlined maintenance workflows, improved resource allocation, and greater adaptability to evolving transit needs and regulatory requirements.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use examples of the disclosure. Various modifications to the illustrated examples will be readily apparent to those skilled in the art, and generic principles presented herein can be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided herein have many useful alternatives and fall within the scope of examples of the disclosure.

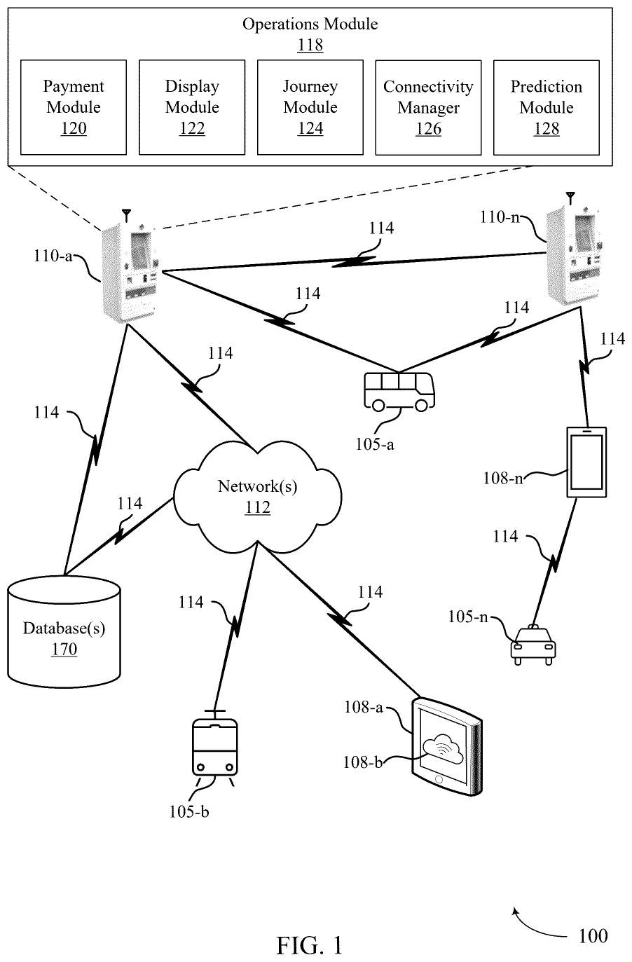

FIG. 1 is a schematic diagram of a ticket vending machine 110 within a system 100 according to a disclosed example. The system 100 may include ticket vending machines (TVMs) 110-a through 110-n (collectively TVMs 110), a network 112, a database 170, one or more transit vehicles 105-a through 105-n (collectively transit vehicles 105), and a set of user devices 108-a through 108-n (collectively user devices 108) all communicatively coupled by one or more communication links 114.

The TVM 110 shown within FIG. 1 may include an operations module 118 with one or more subcomponents. The operations module 118 may include a payment module 120, a display module 122, a journey module 124, a connectivity manager 126, and a prediction module 128. The TVM 110 may be configured to receive input data including but not limited to payment information, destination selection, ticket type selection, travel date and time, quantity of tickets, language preference, personal identification data, and confirmation or approval of selections. In some examples, the TVM 110 may also receive input related to accessibility features, such as requests for audio guidance, larger text displays, or alternative interface modes to support users with disabilities, per ADA requirements. In some instances, the TVM 110 may receive input data from a user input from the one or more user devices 108 or by manual user interaction with the TVM. Additionally, the TVM 110 may support multi-factor authentication, such as biometric verification or one-time passwords, to enhance transaction security and user identification. The input data received by the TVM 110 via a scanning device, vision system, touchscreen interface, or keypad. Further, the TVM 110 may include additional input mechanisms such as voice recognition systems, contactless sensors, or physical card readers to accommodate a wider range of user preferences and requirements.

The TVMs 110 operations module 118 may be responsible for processing received input data, managing user interactions, and executing ticketing transactions. This may include validating user credentials, checking system availability, and ensuring compliance with transit policies or fare regulations. In some examples, the payment module 120 may facilitate the authorization and processing of payments received via cash, card, or electronic payment methods. The payment module 120 may also handle refunds, transaction reversals, and the application of promotional codes or discounts where applicable. The display module 122 may generate and present graphical user interfaces (GUIs) for user interaction, including prompts, instructions, and transaction confirmations. The display module 122 may also dynamically adjust the interface based on user preferences, detected language, or accessibility requirements, and may present real-time notifications or alerts relevant to the ongoing transaction. The journey module 124 may determine optimal travel routes, calculate fares based on user selections, and generate corresponding ticketing information. The journey module 124 may further provide alternative route suggestions in the event of service disruptions, delays, or other transit anomalies, and may integrate with external mapping services to enhance route planning. The connectivity manager 126 may manage communications between the TVM 110 and external systems, such as the database 170, transit vehicles 105, and user devices 108, via the network 112 and communication links 114. The connectivity manager 126 may also monitor connection quality, initiate failover procedures in case of network disruptions, and support secure data encryption for sensitive transactions. The prediction module 128 may analyze historical and real-time data to forecast passenger demand, optimize ticketing options, or provide travel recommendations, analytics and advertisements to users. Additionally, the prediction module 128 may generate alerts for anticipated high-traffic periods, suggest off-peak travel to users, and assist transit authorities in resource allocation and operational planning.

In some examples, the system 100 described within FIG. 1 may include a plurality of TVMs 110-a through 110-n, each communicatively coupled via the network 112 or communication links 114. The TVMs 110 may be configured to communicate with one another directly or through the network 112 to share operational status, synchronize fare tables, update ticketing information, relay user transaction data, or other elements described herein. As an example, a user may initiate a ticket purchase at one TVM 110 and complete the transaction at a different TVM 110, the system 100 may ensure continuity and consistency of user data and transaction records across the network of TVMs 110. Additionally, the TVMs 110 may coordinate with each other to balance system loads, distribute software updates, or facilitate system-wide maintenance operations in communication with the elements described herein. In some embodiments, communication among TVMs 110 may enable features such as distributed ticket validation, collaborative fraud detection, or the aggregation of usage statistics for centralized analytics.

In other examples, the TVM 110 may further store transaction records, user preferences, and operational status data locally or transmit such data to the database 170 for centralized processing and analytics. The database 170 may store transaction histories, user profiles, fare tables, and predictive analytics data to support system-wide operations and transactions. The TVM 110 may also be configured to support remote diagnostics and software updates via the connectivity manager 126, thereby enabling efficient maintenance and feature enhancements. In certain examples, the TVM 110 may be configured to process transactions, communicate operation status, and relay information to other network components within the system described with respect to FIG. 1.

As described herein, the network 112 may be at least one computing device associated with at least one TVM 110 of a system 100. The transit vehicles 105 may make up a fleet of transit vehicles 105 that may move people or goods within a city, between cities, or a broader region. A transit system may be, for example, a central transit authority, a city subway system, a bus system, a high-speed rail system, a passenger rail system, a ferry system, a metro transit system, a streetcar or tram network, a commuter rail system, an autonomous shuttle service, an on-demand micro transit service, a bike-sharing program, or any other transportation system.

The network 112 may be a local area network (LAN), a wide area network (WAN), or other types of networks, supporting protocols like transmission control protocol/Internet protocol (TCP/IP) over Ethernet. In other examples, the network 112 may also include an Automatic Data Processing (ADP) device connected to a plurality of server devices that may host a plurality of databases and a plurality of client devices. The ADP device may store one or more applications that can include executable instructions that, when executed by the ADP device, cause the ADP device to perform desired actions, such as to transmit, receive, or otherwise process network messages, for example, and to perform other actions described and illustrated herein with reference to the figures. The applications may be implemented as modules or components of other applications. Further, the applications can be implemented as operating system extensions, modules, plugins, or the like.

The network 112 may serve as a system hub, providing computational resources and storage capabilities. The network 112 may include resources to manage and deliver computing services over the Internet or other communication forms. The network 112 may be executed within or as a virtual machine or a virtual server that may be managed in a cloud-based computing environment. Also, the applications may be located in one or more virtual servers running in a cloud-based computing environment rather than being tied to one or more specific physical network computing devices. For example, the applications may be running in one or more virtual machines (VMs). In some examples the network 112 may include elements such as data centers, virtualized resources, cloud services, and security tools. In some aspects, the network 112 may utilize data centers that also host servers capable of processing, storing, and managing network traffic, allowing centralized control without on-site hardware. In some instances, the network 112 may be another type of network, which may not reside on the cloud, or may include one or more aspects of non-cloud-based networks.

In the example of FIG. 1, one ore more user devices 108-a through 108-n (collectively referred to as user devices 108) may be connected to the TVM 110 via communication links 114. In some examples, at least some of the user devices 108 may be used to connect to a TVM 110, confirm or validate a transit fare, or request transit vehicle 105 status from the TVM 110 or system 100. For example, user interactions may be facilitated through dedicated mobile applications, web portals, or integrated digital wallets, allowing users to seamlessly manage their transit activities in communication with the TVM 110. The user devices 108 may exchange user profile information, past transit history, preferred interface settings, other elements described herein with the TVM 110. In some cases, the exchange of information may enable the TVM 110 to personalize user experience, expedite transaction processing, and provide targeted notifications, advertisements or recommendations based on individual travel patterns.

In further examples, one or more user devices 108 may be connected directly to a TVM 110 via a communication link 114, such as a wired connection, Bluetooth, near field communication (NFC), or Wi-Fi, to facilitate secure and efficient data exchange. Through this direct connection, the user device 108 may transmit payment credentials, receive digital tickets, or synchronize user preferences with the TVM 110 in real time. Additionally, the user device 108 may be capable of receiving information about a transit vehicle 105, such as current location, estimated arrival time, occupancy status, or route updates, either from the TVM 110, a transit vehicle 105 or directly from the network 112. This capability may allow a user to make informed travel decisions, adjust itineraries, or receive timely notifications regarding transit vehicle 105 status.

Further, the TVM 110 may be communicatively connected to a payment network such as a bank, a credit card network, or an external fare payment service provider. A payment network may interact with the network 112, the TVM 110, or other elements herein to confirm, authorize, process, or settle fare payment transactions. For example, a user may purchase a transit ticket using the TVM, the payment information is first received by the TVM 110 and is processed. In some examples, the TVM 110 may be capable of receiving payment information in the form of near field communications, a camera, a smart card, a magnetic stripe, a quick response code, or a combination thereof. The TVM 110 may then forward the relevant payment information to the network 112, which in turn communicates with the payment network over the communication network 112 to process the users transit ticket. Within some examples, the TVM 110 may then grant access, print a physical ticket, transmit an e-ticket to a user device 108, or a combination thereof. Additionally, the TVM 110 may store ticket information based on a transaction or transmit the transaction information to the network 112, database 170 or another element as described with respect to FIG. 1.

Additionally, the system 100 described with respect to FIG. 1, may include a cloud network. For example, the network 112 may be a cloud network. In other examples, the system 100 includes a cloud network in addition to the network 112. Here, the cloud may provide cloud-based services, such as remote data storage, processing, or backup for the network 112 or TVM 110. The cloud may exchange data with the TVM 110 and other networked elements via the communication network 112. For example, the cloud may store multi-modal transit operation logs, display settings, predictive analytics, user accounts, or historical data, enabling centralized and scalable management of transit operations. The cloud may also facilitate data analytics, reporting, and machine learning processes by aggregating data from multiple sources within the TVM 110 system 100. In some examples, a cloud may act as an intermediary for distributing software updates or security patches to the TVM 110, network 112, or a user.

A database 170 may also be used within the TVM 110 to store input data, transaction records, fare logs, display settings, or other relevant information. The database 170 may be accessed by the network 112, the TVM 110 or other elements described herein. The database 170 may be connected via communication link 114 as shown.

The at least one database 170 may be provided in the form of one or more data stores, memory units, processors, elastic cache systems, cloud storage systems, logic tables, relational databases (e.g., Structured Query Language (SQL) databases), NoSQL databases, time-series databases, graph databases, data warehouses, data lakes, embedded databases, vector databases, hybrid databases, distributed databases, or similar data storage mechanism, or a combination thereof.

Different types of data may be stored in a single database 170 or may be stored in separate databases 170, or any combination. Each of the one or more databases 170 may be any type of centralized database, distributed database, or the like. For example, a centralized database may reside in one central location which may be accessed by various users, the TVM 110, the network 112, or applications via a network. In another aspect, a distributed database may be spread across multiple servers or nodes in at least one network, with each server managing part of the database 170. Within a distributed database, a user may retrieve data seamlessly, similar to if it was stored within a centralized database.

The communication networks or links 114 may be a LAN, a WAN, or other types of networks, supporting protocols like TCP/IP over Ethernet. In some examples, the communication networks or links 114 may support a Controller Area Network (CAN) protocol. In other examples, the communication network or links 114 may include an ADP device connected to a plurality of server devices that may host a plurality of databases and a plurality of client devices via the communication network or links 114. The ADP device may store one or more applications that can include executable instructions that, when executed by the ADP device, cause the ADP device to perform desired actions, such as to transmit, receive, or otherwise process network messages, for example, and to perform other actions described and illustrated herein with reference to the figures. The applications may be implemented as modules or components of other applications. Further, the applications can be implemented as operating system extensions, modules, plugins, or the like.

Additionally, in some examples, elements within the TVM 110 may include components such as processors, memory, displays, input devices, medium readers, network interfaces, and output devices. The processors may be designed to execute software instructions for performing functions like receiving queries, analyzing them, retrieving resolutions, and displaying results.

In other examples, TVM 100 of FIG. 1 may include computational and storage capabilities such as processing power, memory, networking, and storage required for the computational success of one or more computing programs. In some instances, the ticket vending machine system 100 may integrate cloud computing where applications may access large amounts of computing power on demand, allowing them to scale resources up or down based on computational and storage specifications.

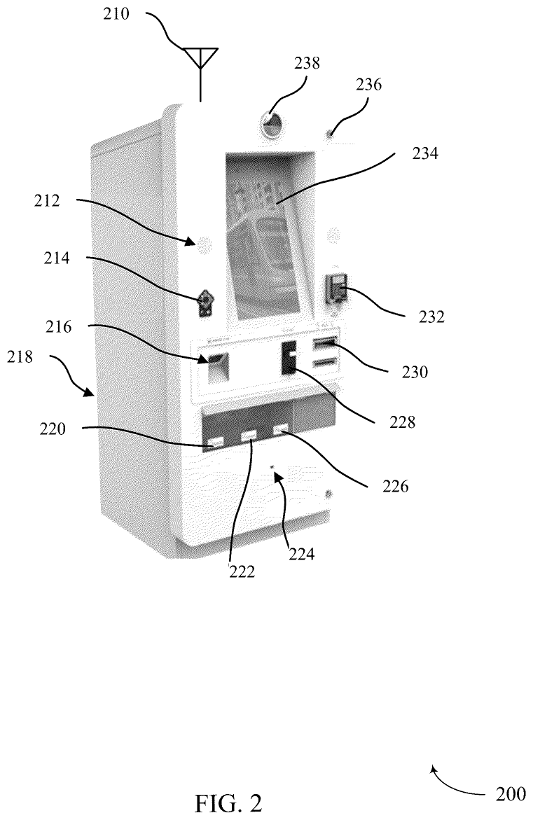

FIG. 2 illustrates an example ticket vending machine 200 comprising a plurality of components configured to facilitate secure, accessible, and versatile ticketing transactions. The TVM 200 may include a housing 240 that may house (e.g., include and support) the various components of the TVM 200. In some examples, the TVM 200 may be an example or, of include one or more aspects of, the TVM 100 of FIG. 1.

Within some examples, the TVM 200 may include an antenna 210, which may be operable to transmit and receive wireless signals for communication with external networks, enabling remote updates, real-time data exchange, and integration with transit management systems. The antenna 210 may further support multiple wireless protocols, such as Wi-Fi, cellular, Bluetooth, or NFC, allowing the TVM 200 to connect with a variety of external devices, payment networks, or cloud-based management platforms. A speaker 212 may be provided to output audio prompts, transaction confirmations, and accessibility features such as audible navigation instructions. The speaker 212 may also be used for broadcasting emergency alerts, public service announcements, or multi-language support for diverse user groups. Additionally, the TVM 200 may further include an Americans with Disabilities Act (ADA) compliant navigation pad and audio jack 214, allowing users with visual impairments to interact with the machine through tactile controls and connect personal audio devices for private navigation or instructions. The ADA navigation pad may feature raised symbols, braille, and high-contrast markings, while the audio jack may support adjustable volume and compatibility with assistive listening devices.

In other aspects, the barcode reader 216 may be configured to scan printed or digital barcodes, enabling the validation of tickets, vouchers, or promotional codes. The barcode reader 216 may support one-dimensional (1D) and two-dimensional (2D) barcodes, including QR codes, and may be positioned for easy access at various heights for ADA compliance. A heating, ventilation, and air conditioning (HVAC) system 218 may be integrated within the TVM 200 to regulate the internal temperature and humidity, ensuring reliable operation of sensitive electronic and mechanical components under varying environmental conditions. The HVAC system 218 may include sensors to monitor internal climate and may automatically adjust fan speeds, heating, or cooling based on real-time data, protecting the TVM 200 from overheating, condensation, or freezing. Further, a smart/chip dispenser 220 may dispense contactless smart cards or chip-based fare media, supporting a variety of ticketing formats. The smart/chip dispenser 220 may also encode or activate cards with user-specific fare products, loyalty programs, or event access, and may be designed for rapid, high-volume dispensing in busy transit environments. The TVM 200 may further include a paper ticket printer 222 operable to print and dispense standard transit tickets for user convenience. The printer 222 may feature high-speed thermal printing, automatic paper cutting, and low-paper sensors to alert maintenance staff when replenishment is recommended.

In other examples, a proximity sensor or motion sensor 224 may detect the presence or approach of a user, enabling features such as automated screen activation, lighting adjustments, or security monitoring. The proximity sensor 224 may also enable energy-saving modes when the machine is idle and may trigger the display of welcome screens or language selection prompts upon user approach. The receipt or QR code printer 226 may output transaction receipts or QR codes for digital ticketing, mobile integration, or promotional redemption. The printer 226 may support customizable receipt formats, branding, and the inclusion of promotional offers or survey links. Additionally, the TVM 200 may include a coin validator and smart hopper 228, configured to accept, validate, and sort coins of various denominations, as well as dispense change. The smart hopper 228 may keep real-time counts of each denomination, provide alerts for low or full coin bins, and select an efficient composition of change returned to the user based on the current inventory. A bank note recycler 230 may be provided to accept, validate, and recycle paper currency, improving cash management efficiency and reducing the need for frequent refilling. The bank note recycler 230 may authenticate notes using optical and magnetic sensors, reject counterfeit bills, and store validated notes for future use as change, thereby reducing operational costs and service visits.

In other aspects, a credit card terminal 232 may be operable to process payment card transactions via magnetic stripe, chip, or contactless methods, supporting a broad range of user payment preferences. The terminal 232 may be EMV and PCI compliant, support mobile wallet payments (such as Apple Pay, Google Pay, etc.), and provide PIN entry for secure debit transactions. The TVM 200 may further include a display or touch screen 234, which may present a graphical user interface, display transaction information, and receive user input via touch or gesture. The display 234 may support high-resolution graphics, multi-language interfaces, adjustable brightness for outdoor visibility, and real-time feedback or error correction to guide users through the ticketing process. Additionally, a tamper-resistant lock 236 may secure the internal components of the TVM 200, protecting against unauthorized access or theft. The lock 236 may be integrated with remote monitoring systems, generate intrusion alerts, and require multi-factor authentication for authorized service personnel. The TVM 200 may also include a fisheye security camera 238, providing wide-angle video surveillance of the machine and its immediate surroundings to deter tampering, vandalism, or other security threats. The security camera 238 may feature night vision, motion detection, and cloud-based video storage, supporting both real-time incident response and post-event auditing by transit authorities.

In some examples, the TVM 200 may be designed to receive input data associated with at least one user via the user interface and identify at least one query from the input data associated with the at least one user. The TVM 200 may output, to a transportation ticketing system, at least one signal indicating an information request related to the at least one query. The TVM 200 may be further designed to receive, from the transportation ticketing system, at least one signal indicating information related to the information request. The TVM 200 may also be designed to output, via the user interface, at least one signal indicating an answer to at least one query based at least in part on the information. In some examples, the query may be a user request and the answer may be a response to the user request.

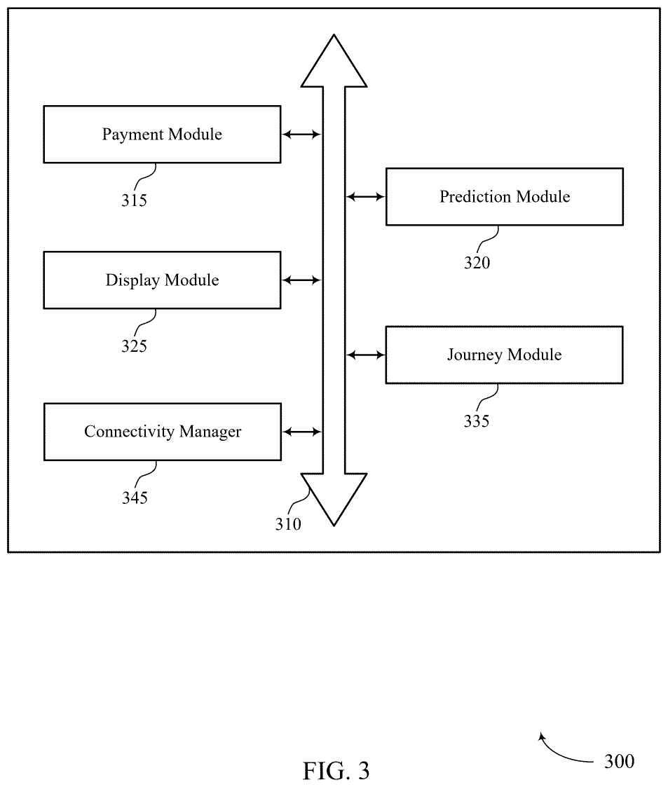

FIG. 3 is a block diagram of the operations module 300 that supports various interactions for a TVMs system in accordance with one or more aspects of the present disclosure. In some cases, the operations module 300 may be implemented as part of one or more processors. The operations module 300 may also be provided in the form of a single module or separate modules, as described within FIG. 1. In some examples, the operations module 300 may be an example of, or include one or more aspects of, the operations module 118 of FIG. 1. In some instances, the operations module 300 may be a single device (e.g., computing device 108-a) that includes separate components or modules as shown in the example of FIG. 1. However, in other instances, the operations module 300 may be part of a collection of individual devices, wherein each device may include one or more modules.

The operations module 300 may include a payment module 315, a display module 325, a connectivity manager 345, a prediction module 320, and a journey module 335. The operations module 300 may be an example of, or include one or more aspects of, the operations module 118 and 425 as described with respect to FIGS. 1, 2, and 4.

The components of the operations module 300 may be interconnected and communicate via a bus 310. The bus 310 may enable communication via any standard or specification such as peripheral component interconnect, peripheral component interconnect express, parallel advanced technology attachment, or serial advanced technology attachment. The at least one bus 310 may be provided in the form of a single bus or multiple buses that are operatively interconnected.

Within some examples, the payment module 315 of the operations module 300 may be configured to process a variety of fare payment methods, including but not limited to cash, credit or debit cards, and digital wallet transactions. In some examples, the payment module 315 may further manage the application of promotional codes, discounts, refunds, and transaction reversals, thereby supporting flexible and secure payment operations within the TVM.

In other aspects, the display module 325 may be responsible for generating and presenting graphical user interfaces (GUIs) that facilitate user interaction with the TVM. The display module 325 may display prompts, instructions, transaction confirmations, and real-time notifications, and may dynamically adapt the interface based on detected user preferences, selected language, or accessibility requirements to enhance the overall user experience.

Additionally, the connectivity manager 345 may maintain secure and reliable communication between the operations module 300 and external systems, such as remote databases, transit vehicles, and user devices. In some examples, the connectivity manager 345 may monitor network status, manage data encryption, and initiate failover procedures to ensure uninterrupted and secure data transmission.

In some examples, the prediction module 320 may be configured to analyze historical and real-time data to forecast passenger demand and optimize ticketing options. The prediction module 320 may further provide travel recommendations, generate alerts for anticipated high-traffic periods, and deliver analytics or targeted advertisements to users or transit authorities.

In other examples, the journey module 335 may determine optimal travel routes, calculate fares based on user selections, and generate corresponding ticketing information. In some examples, the journey module 335 may provide alternative route suggestions in response to service disruptions or delays and may integrate with external mapping services to support comprehensive route planning and travel assistance.

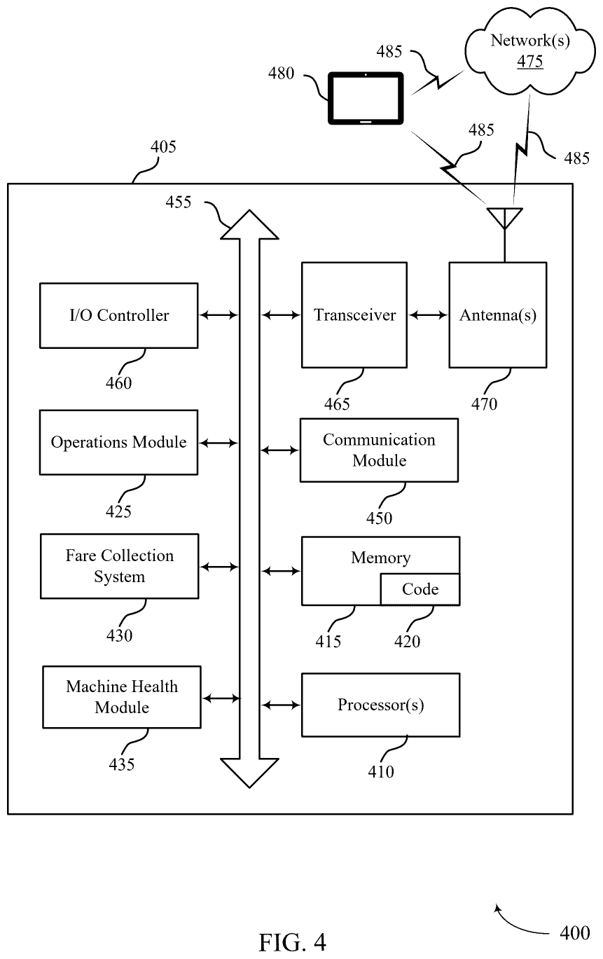

FIG. 4 is a block diagram of a computing environment 400 that supports the ticket vending machine as described in accordance with one or more aspects of the present disclosure. The computing environment 400 may include at least one device 405, at least one computing device 480, and at least one network 475. In some instances, the at least one user device 405 may be, or include aspects of, the TVM 110 or the one or more user devices 108 of FIG. 1. In some instances, the at least one network 475 may be, or include aspects of, the at least one network 112 of FIG. 1. The at least one user device 405 may include at least one input/output (I/O) controller 460, a communication module 450, at least one memory 415 storing code 420, at least one processor 410, at least one transceiver 465, at least one antenna 470, at least one operations module 425, at least one fare collection system 430, at least one machine health module 435, and at least one bus 455. As described herein, the operations module 425 may be an example of, or include one or more aspects of, the operations module 118 described with respect to FIG. 1.

The I/O controller 460 may manage input and output signals for the device 405. The I/O controller 460 may also manage peripherals not integrated into the at least one user device 405. In some cases, the I/O controller 460 may represent a physical connection or port to an external peripheral. In some cases, the I/O controller 460 may utilize an operating system such as iOS®, ANDROID®, MS-DOS®, MS-WINDOWS®, OS/2®, UNIX®, LINUX®, or another known operating system. Additionally, or alternatively, the I/O controller 460 may represent or interact with a modem, a keyboard, a mouse, a joystick, a trackball, a microphone, a touchpad, a touchscreen, a tablet pen, a biometrics device, a display, a screen, a monitor, a camera, a webcam, an external storage device, a speaker, lab equipment, a sensor, a printer, a scanner, or similar devices. In some cases, the I/O controller 460 may be implemented as part of one or more processors, such as the at least one processor 410. In some cases, a user may interact with the at least one user device 405 via the I/O controller 460 or via hardware components controlled by the I/O controller 460.

In some cases, the device 405 may include the at least one antenna 470. However, in some other cases, the device 1605 may have more than one antenna 470, which may be capable of concurrently transmitting or receiving multiple wireless transmissions. The transceiver 465 may communicate bi-directionally via the at least one antenna 470 using wired or wireless links as described herein. For example, the transceiver 465 may represent a wireless transceiver and may communicate bi-directionally with another wireless transceiver. The transceiver 465 may also include a modem to modulate the packets, to provide the modulated packets to the at least one antenna 470 for transmission, and to demodulate packets received from the at least one antenna 470. The transceiver 465, or the transceiver 465 and the at least one antenna 470, may be an example of a separate transmitter or a separate receiver.

The communication module 450 may facilitate communication between the device 405 and the network 475 and/or communication between the various components of the device 405, the computing device 405, and the network 475 via at least one wired or wireless network connection 485.

The memory 415 may be provided in the form of a single memory unit or multiple memory units and may be provided in the form of one or more articles of manufacture and/or machine components. The memory 415 may include static memory, dynamic memory, or both in communication. In some examples, the memory 415 may be one or more tangible storage mediums that can store data and executable instructions and may be non-transitory during the time instructions are stored therein. The memory 415 may be volatile or non-volatile, secure or encrypted, and unsecure or unencrypted.

The at least one memory 415 may store computer-readable, computer-executable, or processor-executable code, such as the code 420. The code 420 may include instructions that, when executed by the at least one processor 410, cause the device 405 to perform various functions described herein. The code 420 may be stored in a non-transitory computer-readable medium such as system memory or another type of memory. In some cases, the code 420 may not be directly executable by the at least one processor 410 but may cause a computer (e.g., when compiled and executed) to perform functions described herein. In some cases, the at least one memory 415 may include, among other things, a basic I/O system (BIOS) which may control basic hardware or software operation such as the interaction with peripheral components or devices. The code 420 stored in the memory 415 may include the software code for at least one operations module 425, at least one fare collection system 430, at least one machine health module 435, and the other components to operate.

The at least one processor 410, in some instances, may be a general-purpose processor or may be part of an application-specific integrated circuit (ASIC). In other instances, the at least one processor 410 may be at least one of an intelligent hardware device, a microprocessor, a microcomputer, a processor chip, a controller, a microcontroller, a digital signal processor (DSP), a state machine, a quantum processor, a programmable logic device (PLD), a central processing unit (CPU), a graphics processing unit (GPU), a field programmable gate array (FPGA), a neural processing units (NPUs) (e.g., neural network processors or deep learning processors (DLPs)), discrete gate or transistor logic, or at least one discrete hardware component. Additionally, any processor described herein may be provided in the form of a single processor, multiple processors, and/or parallel processors. Multiple processors may be included in or coupled to, a single device or multiple devices. In some cases, the at least one processor 410 may be configured to operate a memory array using a memory controller. In some other cases, a memory controller may be integrated into the at least one processor 410. The at least one processor 410 may be configured to execute computer-readable instructions stored in a memory (e.g., the at least one memory 415) to cause the device 405 to perform various functions (e.g., functions or tasks supporting the TVMs ticketing and planning systems). For example, the device 405 or a component of the device 405 may include at least one processor 410 and at least one memory 415 coupled with or to the at least one processor 410, the at least one processor 410 and the at least one memory 415 configured to perform various functions described herein.

In some examples, the at least one processor 410 may include multiple processors and the at least one memory 415 may include multiple memories. One or more of the multiple processors 410 may be coupled with one or more of the multiple memories 415, which may, individually or collectively, be configured to perform various functions described herein. In some examples, the at least one processor 410 may be a component of a processing system, which may refer to a system (such as a series) of machines, circuitry (including, for example, one or both of processor circuitry (which may include the at least one processor 410) and memory circuitry (which may include the at least one memory 415)), or components, that receives or obtains inputs and processes the inputs to produce, generate, or obtain a set of outputs. The processing system may be configured to perform one or more of the functions described herein. For example, the at least one processor 410 or a processing system including the at least one processor 410 may be designed to, designable to, configured to, configurable to, or operable to cause the device 405 to perform one or more of the functions described herein. Further, as described herein, being “designed to,” being “designable to,” being “configured to,” being “configurable to,” and being “operable to” may be used interchangeably and may be associated with a capability, when executing code 420 (e.g., processor-executable code) stored in the at least one memory 415 or otherwise, to perform one or more of the functions described herein.

The components of the device 405 may be interconnected and communicate via the at least one bus 455 or other communication link. The at least one bus 455 may enable communication via any standard or specification such as peripheral component interconnect, peripheral component interconnect express, parallel advanced technology attachment, or serial advanced technology attachment. The at least one bus 455 may be provided in the form of a single bus or multiple buses that are operatively interconnected.

The operations module 425 may include a plurality of subcomponents as described with respect to FIG. 1 configured to manage the core functions of the device 405. The operations module 425 may comprise a payment module, a display module, a journey module, a connectivity manager, and a prediction module as described herein. The operations module 425 may serve as the central controller for the device 405, orchestrating a range of functions essential for user interaction and system performance. For example, a payment submodule manages the acceptance and processing of a variety of payment types, including cash, card, and digital transactions, and is equipped to handle special cases such as refunds, reversals, or application of discounts and promotional codes. A display submodule governs the user interface, generating intuitive graphical prompts and dynamically tailoring the display to accommodate user preferences, selected language, or accessibility needs, as well as relaying transaction statuses and alerts in real time. The journey submodule calculates fares, determines travel routes, and issues ticketing information, while also offering alternative travel suggestions during disruptions and leveraging external mapping resources for enhanced route planning. Connectivity is maintained by a dedicated manager, which ensures secure and reliable data exchange between the device 405 and external systems, such as databases, vehicles, and user devices, while also overseeing connection stability, security protocols, and backup procedures in the event of network failure. Finally, a prediction submodule leverages historical and live data to anticipate passenger flow, optimize fare structures, and deliver targeted travel advice, system analytics, or advertisements, and can further generate alerts for peak travel times, recommend off-peak journeys, and support transit agencies in resource planning and operational adjustments.

The fare collection system 430 may be responsible for securely and efficiently receiving and processing transactional information, such as paper money, coins, debit and credit card payments, scanned tickets, and other forms of payment and fare validation, from users interacting with the device 405. The fare collection system 430 may store detailed transactional information, monitor and record change counts, and provide real-time visibility into the amount of cash currently held within the machine. In some examples, the fare collection system 430 may utilize predictive analytics to estimate when the machine will be out of cash or require replenishment and may suggest optimal cash levels to maintain within the machine based on historical and current usage patterns. This predictive capability may help ensure that cash handling schedules are optimized, reducing the risk of cash shortages or excessive cash storage, and improving operational efficiency by recommending the most effective intervals for machine servicing and cash collection.

The machine health module 435 may be configured to support the comprehensive management and monitoring of the device 405 using Internet of Things (IoT) technologies and over-the-air (OTA) updates. The machine health module 435 may provide real-time updates on system status, enable remote screen changes, and facilitate fare adjustments as needed. In addition, the module may continuously monitor critical aspects such as machine power, system health, network connectivity, and security protocols, as well as manual and automated subsystems. Physical components of the TVM monitored by the machine health module 435 may include the bill and coin acceptors, card readers, ticket dispensers, receipt printers, display screens, input keypads or touch screens, and internal sensors such as temperature, humidity, or vibration sensors. The module may track the operational status of these components, detect jams or malfunctions in cash handling or ticket dispensing mechanisms, and monitor the wear and tear of moving parts. The machine health module 435 may regulate and report on the operational state of both hardware and software components and may provide timely updates and alerts to users or connected networks regarding maintenance needs, security events, or system performance. For example, the module may issue alerts if the ticket printer is low on paper, if the cash box is nearing capacity, or if the display screen experiences a fault. This module may also support the deployment of software updates, configuration changes, and diagnostic routines to ensure the reliability, security, and optimal performance of the device 405.

In some examples, the operations module 425 may be designed or configured to perform various operations (e.g., processing, receiving, monitoring, transmitting) using or otherwise in cooperation with the transceiver 465, the at least one antenna 470, or any combination thereof. Although the at least one operations module 425, at least one fare collection system 430, and the at least one machine health module 435 are illustrated as separate components, in some examples, one or more functions described with reference to the at least one operations module 425, at least one fare collection system 430, and the at least one machine health module 435 may be supported by or performed by the at least one processor 410, the at least one memory 415, the code 420, or any combination thereof. For example, the code 420 may include instructions executable by the at least one processor 410 to cause the device 405 to perform various aspects related to the TVMs ticketing and planning systems as described herein, or the at least one processor 410 and the at least one memory 415 may be otherwise configured to, individually or collectively, perform or support such operations.

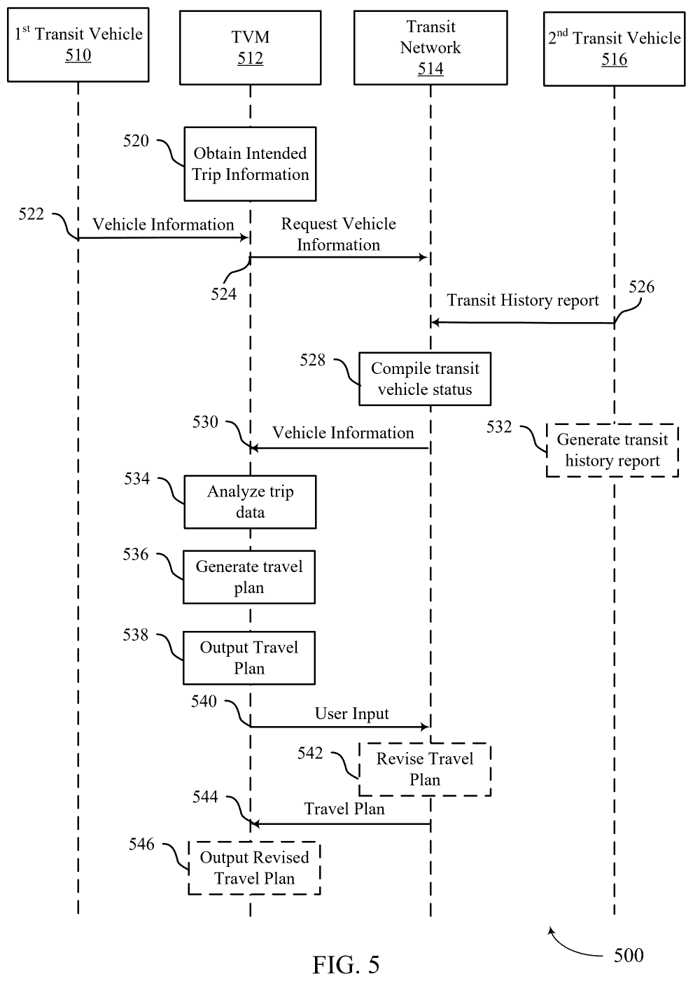

FIG. 5 is a swimlane diagram illustrating an example system 500 for a TVM 512. The system 500 may include a TVM 512, a transit network 514, a first transit vehicle 510, and a second transit vehicle 516. The TVM 512 within FIG. 5 may include one or more components of the TVM 110 as described herein. The first transit vehicle 510 and the second transit vehicle 516 may be an example of, or may include aspects of, the transit vehicles 105 described within FIG. 1. The systems described with respect to FIG. 5 may communicate with one another via communication networks or links 114 or other communication methods. The transit network 514 may correspond to the network 112 of FIG. 1 described with respect to FIG. 1.

At 520, the TVM 512 may obtain intended trip information. This trip information may include a user's selected origin and destination, preferred travel time or date, ticket type, number of passengers, route preferences, and any applicable discounts or promotional codes, which may be transmitted from one or more transit vehicles 105, user devices 108 or other TVMs 110 as described in connection with FIG. 1. As described herein the TVM 512 may be configured to accept various forms of input, such as contactless payment tokens, physical coins or paper bills, QR codes, NFC signals, or digital tickets. In some cases, the input data may include biometric authentication (such as fingerprint or facial recognition), printed barcodes, Bluetooth Low Energy (BLE) signals, or smartcards. The TVM 512 may also accept various forms of currency, contactless payment, special event tickets, or time-based travel authorizations.

At 522, the TVM 512 may transmit vehicle information from the first transit vehicle 510. This transmission may include the received input data and may initiate the process of purchasing a transit ticket, selecting a travel plan, or receiving a physical transit ticket. The confirmation request may be securely transmitted over a communication network 112. For example, the confirmation request may utilize end-to-end encryption, VPN tunnels, or secure web protocols such as HTTPS to protect sensitive passenger and payment information.

At 524, the TVM 512 may transmit a request for vehicle information to the transit network 514. This request may include details about the intended trip, such as the selected route, desired departure or arrival times, and any specific travel constraints or preferences provided by the user. The vehicle information request may be formatted to comply with transit network protocols, allowing for seamless integration with a variety of transit management systems or databases. In some examples, the request may also include authentication tokens or encrypted identifiers to ensure secure and authorized data exchange between the TVM 512 and the transit network 514.

At 526, the transit network 514 may receive a transit history report from the second transit vehicle 516. This report may contain historical and real-time data related to one or more transit vehicles, including departure and arrival times, service reliability, occupancy levels, and any recent incidents or delays. The transit history report may be compiled from various sources such as on-board vehicle sensors, historical logs, or third-party data feeds, and may be formatted for rapid processing by the requesting TVM 512. In some cases, the report may also include predictive analytics or recommendations based on observed travel patterns and system performance.

At 528, the transit network 514 may compile a transit vehicle status. Here, the transit network 514 may aggregate information from the received transit history report and any real-time updates from the first transit vehicle 510, the second transit vehicle 516, or other elements in connection with the TVM 110 of FIG. 1. The compiled status may include current vehicle locations, estimated arrival or departure times, route deviations, and maintenance alerts. This information may be used to support dynamic travel planning, improve passenger communication, or facilitate informed trip analytics within the transit system.

At 530, the compiled vehicle information may be transmitted from the transit network 514 back to the TVM 512. This vehicle information may be formatted for direct integration into the TVM's journey planning algorithms and may include both static and dynamic data relevant to the user's intended trip. For example, the vehicle information may detail available connections, transfer points, expected wait times, and any service advisories that could impact the user's travel experience of ticket purchasing options.

At 532, the second transit vehicle 516 may also generate a transit history report, either in response to a direct request from the transit network 514 or as part of a routine data sharing protocol. This report may be used to further refine the travel plan, verify service availability, or update the transit network's operational records. The generated transit report may be stored within a database, such as the database 170 within FIG. 1 or other storage mediums described herein.

At 534, the TVM 512 may analyze the received trip data and vehicle information. This analysis may involve evaluating possible routes, comparing travel times, and considering user-specified preferences or constraints. The TVM 512 may utilize advanced algorithms, real-time data feeds, and historical performance metrics to identify the most efficient or convenient travel plan for the user. In some examples, the analysis may also incorporate predictive modeling to account for expected delays, congestion, or service interruptions.

At 536, the TVM 512 may generate a travel plan based on the analyzed data. The travel plan may specify the recommended route, departure and arrival times, transfer points, and any special instructions or advisories for the passenger. The generated travel plan may be customized to the user's preferences, such as minimizing travel time, maximizing comfort, or avoiding certain transit modes or stations.

At 538, the TVM 512 may output the generated travel plan to the user. The output may be presented via a graphical display, printed ticket, mobile notification, or other user interface elements integrated with the TVM 512. The travel plan output may include visual maps, step-by-step directions, fare information, and real-time updates regarding vehicle status or service advisories.

At 540, the TVM 512 may receive additional user input in response to the output travel plan. The user input may include requests to modify the route, change travel times, add or remove stops, or update preferences such as accessibility requirements or fare options. The TVM 512 may process this input and determine whether a revised travel plan is necessary.

At 542, based on the user input, the TVM 512 may initiate a process to revise the travel plan. This may involve re-analyzing available vehicle information, revising user customizations, updating route calculations, and incorporating any new user constraints or preferences. The revised travel plan may be generated in real time, ensuring that the user receives the most current and relevant travel recommendations.

At 544, the TVM 512 may output the revised travel plan to the user, providing updated directions, schedules, fare information, and any additional advisories or notifications as needed. The revised travel plan may be delivered through the same user interface or output mechanisms as the original travel plan.

At 546, the TVM 512 may confirm the output of the revised travel plan. This confirmation may include a summary of the selected route, ticketing details, and a record of the user's interactions with the system. In some cases, the TVM 512 may also store the revised travel plan and associated metadata in a local or remote database for future reference, auditing, or service optimization purposes.

In this manner, system 500 may provide an integrated and secure process for receiving and handling user trip information, validating inputs, verifying payments, compiling vehicle data, and supporting the generation of travel plans. The system architecture may allow for timely processing of user interactions and planning of transit routes, support various types of payment and ticketing methods, and help maintain the integrity and privacy of data. Information such as trip details, ticketing data, and user preferences may be stored or transmitted in a variety of ways, which could include local or remote storage, linkage to user profiles, or communication with other devices or network elements. The system may utilize security features such as encrypted communication or authentication to help protect sensitive data. Stored or transmitted data may be used for a range of purposes, such as auditing, analytics, or service improvement, and users may be provided with travel information through different types of interfaces.

Further, the elements described with respect to FIG. 1, FIG. 3, or FIG. 5 may employ techniques for protecting passenger privacy and supporting payment verification. For instance, devices within the system may be capable of processing payment information in a secure manner, which could involve generating and handling encrypted or hashed data. Such security features may be implemented at various stages, either within the device or elsewhere in the system, to help safeguard personal and payment information.

In other examples, devices within the system may be designed to receive and process different kinds of fare-related and non-fare-related information, which could be categorized or grouped in a number of ways. These categories may include, for example, characteristics relating to fare payment or passenger activity. Information may be displayed, stored, or transmitted as appropriate, and may be used for reporting, analytics, or integration with other systems. The system may support a range of approaches for presenting or outputting summary information to operators or users, depending on the specific application or requirements.

The travel plans, along with relevant user data and transaction history described with respect to FIG. 5, may be transmitted to other TVMs 110 within the network to enable seamless continuation of service or retrieval of travel information at a different location for a user's analysis. Additionally, this information may be linked to a user profile or account, allowing the user to access their travel history, preferences, and active tickets through a dedicated interface, such as a mobile application or web portal. In certain examples, the TVM 512 may also transmit notifications or confirmations to the user's device, providing digital receipts, real-time updates, or reminders related to the revised travel plan. Furthermore, the stored or transmitted data may be utilized for analytics, reporting, or integration with third-party mobility platforms to enhance the overall transit experience.

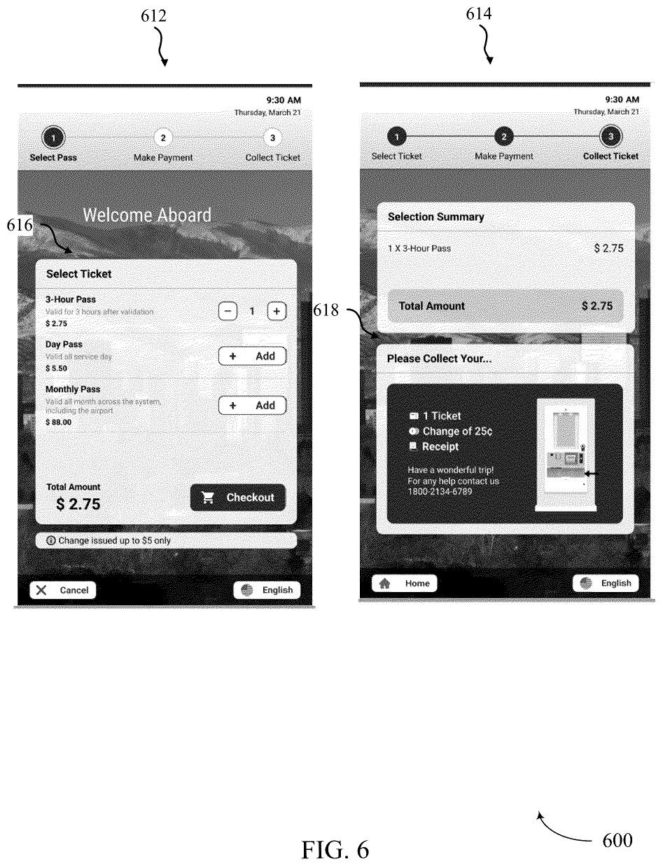

FIG. 6 illustrates example user interface screens 612 and 614 for a ticket vending machine, depicting a step-by-step transaction flow for purchasing transit tickets. In the first screen 612, the user may be presented with a ticket selection interface 616, where various ticket options such as a 3-hour pass, day pass, or monthly pass, are displayed along with their respective prices and descriptions. The user may select the desired ticket type and quantity using intuitive controls, and the interface dynamically updates the total amount due. Upon finalizing the selection, the user can proceed to checkout and payment by activating the checkout button 618. In the subsequent screen 614, a summary of the selected ticket(s) and the total payment amount are shown, followed by collection instructions for the user. The interface 618 may prompt the user to collect their printed ticket, any change dispensed, and a transaction receipt.

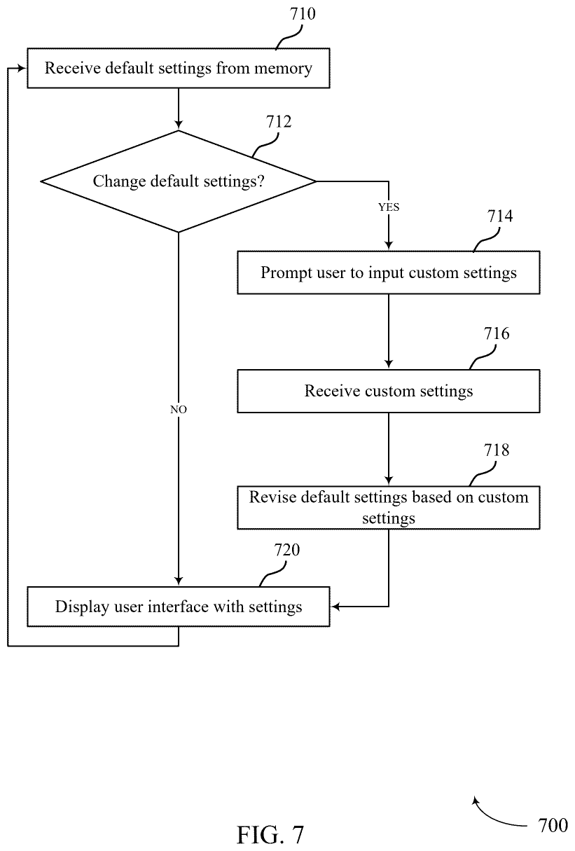

FIG. 7 is a flowchart illustrating an example system 700 for user customization on a TVM, such as the TVM with respect to FIGS. 1, 2, and 4. The system 700 may include various components in communication with the TVM systems described herein. At 710, the system 700 may receive default display settings from memory. These default settings may include agency-branded interface elements such as colors, logos, fonts, advertisements, and imagery to reflect the transit agency's identity. The settings may further encompass theming options for special events, holidays, or local celebrations, as well as dynamic interface changes that may adjust based on the time of day or the machine's location. Default configurations may also specify the initial language menu, accessibility options, and interface layout, and may be centrally managed by agency staff through a remote dashboard or local configuration tools. In some examples, the journey module 124 described with respect to FIG. 1 may be operable with the system 700 described herein.

At 712, the system 700 may determine whether the user or a transit agency wishes to change the default settings on a TVM. This determination may be made by presenting an interactive element on the graphical user interface, user device, or remote server such as a “Customize” button or a prompt such as a prompt at the start of a transaction. The system may allow for real-time identification of user type (e.g., frequent rider, tourist, staff) and may present different customization options accordingly. The interface may also support agency-initiated changes, such as a scheduled update or an emergency mode activation triggered remotely.

If a change to the default settings is requested, at 714, the system 700 may prompt the user or agency staff to input custom settings. The prompt may include options for selecting from an extensive language menu, adjusting text size, enabling high-contrast or colorblind-friendly themes, or activating screen reader and text-to-speech features for ADA compliance. Additional prompts may allow for interface zoom, tactile feedback, braille support, audio navigation customization, and volume control. Agency staff may be given access to a drag-and-drop interface builder for workflow and layout design, configurable menus and button placements, and real-time preview/testing environments.

At 716, the system 700 may receive custom settings input from the user or agency staff. These settings may be provided through a touchscreen, physical controls, voice input, or assistive technology interfaces. Inputs may include user-specific preferences such as preferred language, accessibility adjustments, interface simplification, or custom transaction flows for special fare programs or events. The system may also capture agency-driven changes for interface branding, menu configuration, or feature enablement/disablement based on location, time, or user group.

At 718, the system 700 may revise the default display settings based at least in part on the received custom settings. This revision may take place in real time, allowing the user interface to immediately reflect the new preferences or agency directives. The system may utilize personalization algorithms to adapt the interface for returning users, context-aware adjustments for peak hours or special scenarios, and OTA (Over-the-Air) deployment of new layouts or features network-wide. Settings may be stored in association with a user profile or account, enabling the machine to recall and apply customizations in future sessions. Agency staff may manage and monitor these updates through a centralized dashboard, with options for rolling back changes or scheduling future deployments. Within some examples, the custom setting may be stored within a database or saved within a user profile.

At 720, the system 700 may display the user interface or other customized aspects of the TVM according to the current settings, whether default or customized. The displayed interface may include localized content, region-specific payment and ticketing rules, and real-time alerts or emergency instructions as needed. The system may also provide built-in analytics to track user interaction, collect feedback, support A/B testing of interface designs, and facilitate staff or user training via simulation or tutorial modes.

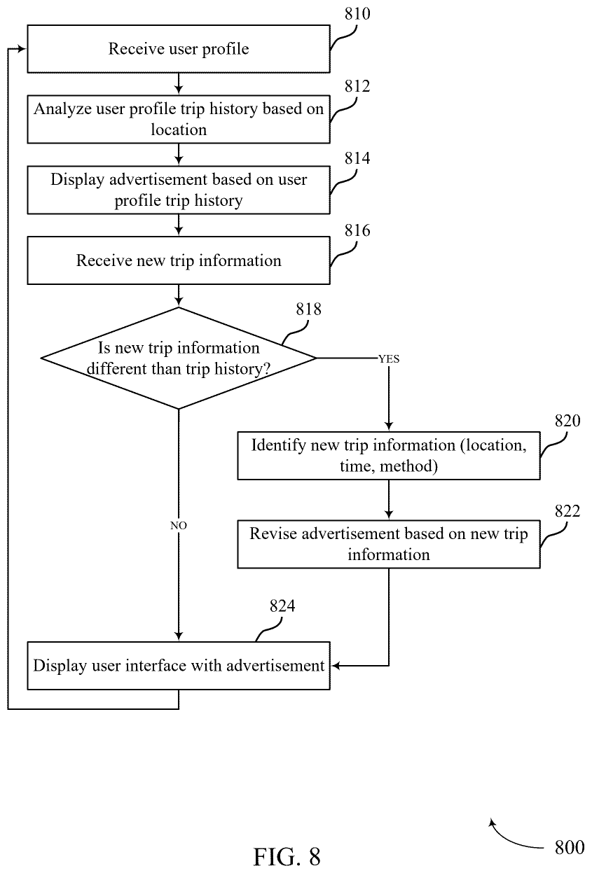

FIG. 8 is a flowchart illustrating an example system 800 for dynamic advertisements on a TVM, such as the TVM with respect to FIGS. 1, 2 and 4. The system 800 may include various components in communication with the TVM systems described herein. System 800 may enable targeted, real-time content delivery based on user behavior, location, and trip context. The system 800 leverages advanced algorithms and user profile data to optimize the selection and presentation of advertisements, improving engagement and creating new opportunities for local business partnerships and advertising revenue. The method also supports privacy controls, personalized ad experiences, and seamless integration with broader transit and digital signage ecosystems. In some examples, the operations module 118 described with respect to FIG. 1 may be operable with the system 800 described herein.

At 810, the system 800 may receive a user profile, which may be created or accessed through account login, card tap, or opt-in identification methods. The user profile may include demographic information, language preferences, historical trip data, advertisement interaction history, and any user-specified privacy or personalization settings. The system may also support anonymous or guest profiles, where data is limited to the current session and not permanently stored.

At 812, the system 800 may analyze the user profile trip history based on location. This analysis may involve reviewing previous travel routes, frequently visited stops, time-of-day patterns, and past advertisement interactions. The system may utilize machine learning algorithms to identify trends, such as preferred destinations, commonly used transit methods, or recurring travel times, and may correlate this information with local events, business offers, or seasonal activities.

At 814, the system 800 may display one or more advertisements based on the analyzed user profile trip history. Advertisements may be selected from a set received from a network or advertiser portal, with each ad assigned to one or more categories such as location, user type, or time of day. The display may include static images, videos, interactive content, or QR codes, and may be tailored for hyper-local relevance, such as nearby businesses, events, or special promotions. The interface may also adapt its language, visuals, and content based on user preferences and local demographics.

At 816, the system 800 may receive new trip information, which may include updated travel plans, new destinations, changes in time or route, or additional passenger data. This information may be entered by the user during the transaction, received from a connected user device, or detected through account activity. The system may also receive real-time contextual data, such as current location, transit delays, or special event notifications.

At 818, the system 800 may determine whether the new trip information is different from the previously analyzed trip history. This determination may be based on changes in travel route, destination, time, or method, as well as any new user interactions or preferences expressed during the session. If the new information is not substantially different, the advertisement display may remain unchanged.

If the new trip information is different from the previous trip history, at 820, the system 800 may identify the specific aspects of the new trip, such as updated location, time, or travel method. The system may use this new information to re-categorize the current session and update the selection criteria for relevant advertisements. Contextual factors such as local events, weather, or crowding may also be considered in this identification step.

At 822, the system 800 may revise the advertisement selection and display based on the newly identified trip information. The system may use advanced algorithms, including predictive analytics and real-time A/B testing, to select the most engaging or relevant advertisements for the user's current context. Advertisers may be able to update or schedule ads in real time, and the system may track engagement metrics, such as impressions and click-through rates, to optimize ongoing ad campaigns.

At 824, the system 800 may display the user interface with the revised advertisement. The displayed advertisement may be interactive, offering the user options to save offers, get directions, or share promotions with others. The system 800 may ensure that advertisements are balanced with essential transit information and comply with agency standards for content appropriateness and privacy. Engagement data, user feedback, and ad performance metrics may be collected and reported to advertisers or agency staff via a secure analytics dashboard, supporting continuous improvement and value tracking for all stakeholders.

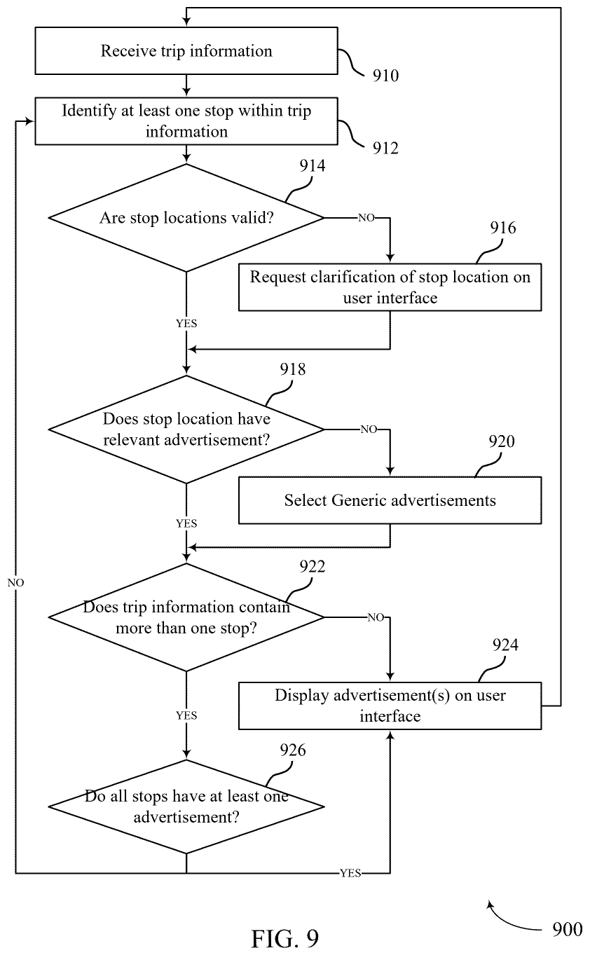

FIG. 9 illustrates an additional system 900 for dynamically selecting and displaying advertisements on a ticket vending machine (TVM) user interface, which may be used instead of the system 800 of FIG. 8 or in combination. The system 900 enables context-aware ad targeting by analyzing trip information, validating stop locations, and ensuring relevant or fallback advertisements are presented for each stop in a user's travel plan. The process improves ad relevance, maximizes engagement opportunities for local businesses, and maintains a seamless user experience even when precise trip data or targeted ads are unavailable.

At 910, the system 900 may receive trip information, which may be entered by the user, retrieved from a user profile, a network, or received from a connected device. The trip information may include details such as origin, destination, intermediate stops, travel times, and selected routes. This data may be utilized to tailor the advertisement content shown during the transaction.

At 912, the system 900 may identify at least one stop within the received trip information. Stops may be specific transit stations, bus stops, transfer points, or other designated locations along the user's route. The system may parse the trip details to extract all relevant stop locations for subsequent ad targeting. At 914, the system 900 may determine whether the identified stop locations are valid. This may involve verifying that the stop data matches known locations in a transit database, checking for data entry errors, or confirming the stops are within supported service areas. If any stop location is deemed invalid or ambiguous, the process may proceed to step 916. At 916, the system 900 may request clarification of the stop location on the user interface. The TVM may prompt the user to confirm or correct the ambiguous stop, for example by selecting from a list, entering additional details, or using a map-based interface. This ensures that subsequent steps are based on accurate and actionable location data.

At 918, the system 900 may determine whether the stop location has a relevant advertisement available. This determination may be made by querying a local or remote advertisement database, using criteria such as stop location, time of day, user profile, or current events. If no relevant advertisement is available for a particular stop, the process may advance to step 920. At 920, the system 900 may select generic advertisements for display. Generic ads may include broader transit-related promotions, agency branding, public service announcements, or advertisements not tied to a specific location. This ensures that the user interface always displays engaging content, even in the absence of highly targeted ads.

At 922, the system 900 may determine whether the trip information contains more than one stop. If only a single stop is present, the process may proceed directly to displaying the selected advertisement(s). If multiple stops are included in the trip, the system may iterate through each stop to ensure comprehensive ad coverage. At 924, the system 900 may display the selected advertisement(s) on the user interface. The display may include a mix of relevant local ads, generic ads, or a combination thereof, depending on the validation and relevance checks performed in previous steps. Advertisements may be presented as static images, videos, interactive content, or QR codes, and may be tailored to the user's language, accessibility needs, and preferences.

At 926, the system 900 may determine whether all stops in the trip have at least one associated advertisement. If any stop lacks a relevant or generic ad, the system may loop back to select additional content or prompt for further clarification. Once all stops are covered, the method ensures a consistent, engaging, and context-aware advertising experience for the user throughout their planned journey. The operations module 118 described in FIG. 1 may facilitate these functions by managing ad selection, user inputs, database queries, and real-time content delivery in coordination with the TVM's user interface and trip planning modules.

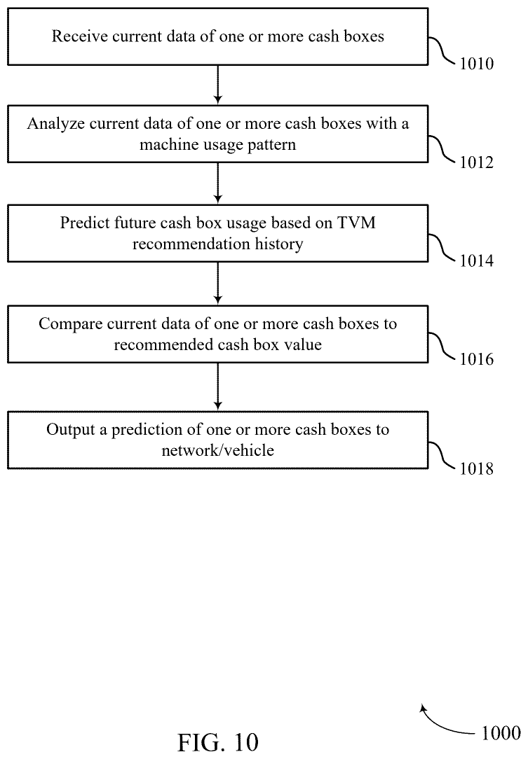

FIG. 10 illustrates an example method 1000 for predictive cash management and optimization in a ticket vending machine (TVM) system. The method enables real-time monitoring, forecasting, and recommendation of cash handling operations, supporting operational efficiency, security, and proactive maintenance scheduling. The system may utilize advanced analytics and machine learning to minimize the risk of cash shortages or overflows, optimize refill schedules, and provide actionable insights to maintenance crews and transit operators.

At 1010, the method 1000 may receive current data of one or more cash boxes within the TVM. This data may include the amount of cash and coins held in each cash box, broken down by denomination, as well as timestamps, transaction logs, and recent refill or collection events. The system may aggregate this information from multiple machines via a live dashboard, providing a comprehensive overview of cash levels across the network or one or more TVMs.

At 1012, the method 1000 may analyze the current data of one or more cash boxes in conjunction with historical machine usage patterns. This analysis may consider transaction frequency, time-of-day trends, seasonal or event-based fluctuations, and any recent anomalies or alerts. Machine learning algorithms may be employed to identify recurring usage patterns, detect unusual cash activity, and assess the likelihood of cash depletion or overflow.

At 1014, the method 1000 may predict future cash box usage based on TVM recommendation history and the analyzed usage patterns. The prediction may account for upcoming events, expected demand surges, and previously observed cash usage rates. The system may generate forecasts for when each cash box is likely to reach critical thresholds either running low or becoming overfilled allowing for early intervention and proactive planning.

At 1016, the method 1000 may compare the current data of one or more cash boxes to recommended cash box values. These recommended values may be dynamically generated to optimize operational efficiency, security, and refill frequency. The system may suggest the ideal amount of cash to load into each machine. Recommendations may also include optimal refill schedules and prioritization of machines most at risk, for example, machines at heavy traffic transit stations.

At 1018, the method 1000 may output a prediction for one or more cash boxes to a network or vehicle. This output may include automated alerts to maintenance crews, dynamic route and schedule optimization for cash collection and refilling, and integration with vehicle routing or asset management platforms. In some instances, the machine will transmit an alert to a user interface to notify a user of the cash level within the TVM. The system may also support remote configuration of cash thresholds, real-time reporting to centralized dashboards, and feedback mechanisms for maintenance staff to log issues or track discrepancies. By leveraging predictive analytics and real-time monitoring, the system 1000 may enhance cash management and improve operational reliability.

At least a portion of the method 1000 may be carried out by one or more Artificial Intelligence (AI) or machine learning predictive models to analyze historical transaction data, including, for example, bill denominations and ticket purchase trends. In some aspects, the method 1000 may analyze current data from one or more cash boxes in conjunction with historical machine usage patterns. For example, the method 1000 may integrate machine learning algorithms to identify recurring usage patterns, detect unusual cash activity, and assess the likelihood of cash depletion or overflow. The method 1000 may include outputting recommendations that may include a recommended refill schedule or prioritization of those ticket vending machines within the system that are most at risk of running out of cash. By understanding the patterns of cash usage specific to each location in which a TVM is deployed, the predictive model may predict a recommended cash mix and volume needed in each TVM. This technique may reduce replenishment visits, thereby reducing operational costs, saving time, improving user experience, and enhancing revenue efficiency.

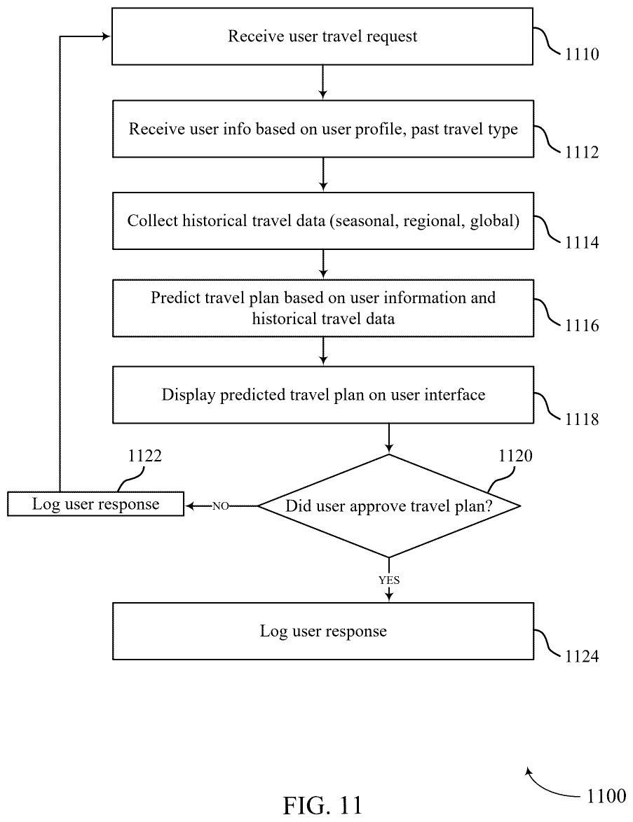

FIG. 11 illustrates an example method 1100 for a recommendation system in a transportation ticketing environment, such as a ticket vending machine or associated network. The system leverages predictive analytics and user profile integration to provide personalized, context-aware journey recommendations. By analyzing historical travel data, user preferences, and real-time contextual factors, the system may be able to suggest relevant travel plans and dynamically refine recommendations based on user feedback and evolving trends.

At 1110, the method 1100 may receive a user travel request. This request may be initiated through a TVM, mobile app, or web interface, and may include information such as desired origin, destination, preferred travel times, ticket type, or any relevant travel constraints. The system may also prompt the user for additional preferences or requirements, such as accessibility needs or preferred modes of transit. At 1112, the method 1100 may receive user information based on a user profile, past travel type, or other identifying data. The user profile may store previous travel history, favorite or frequently used routes, payment information, and any saved preferences for journey planning. The profile may be accessed via account login, card tap, or opt-in identification, and can be configured to remember user-specific settings for future interactions.

At 1114, the method 1100 may collect historical travel data, which may include seasonal, regional, global travel patterns, or other historical travel data as described herein. This data may be gathered from past transactions, aggregated system usage, city event calendars, and external data sources such as weather or traffic feeds. The system may analyze data for trends such as peak travel times, popular routes during holidays or local events, and frequently chosen destinations, to enhance the relevance of its recommendations. Further, at 1116, the method 1100 may predict a travel plan based on the user information and historical travel data. Predictive analytics may be used to suggest the most likely or efficient routes, recommend ticket types or fare products based on usage patterns, and highlight alternate routes during peak periods or disruptions. The method 1100 may also offer recommendations for new services, last-mile options, or relevant local events and attractions. Personalization algorithms may adapt the suggestions to the user's language, accessibility preferences, and real-time context.

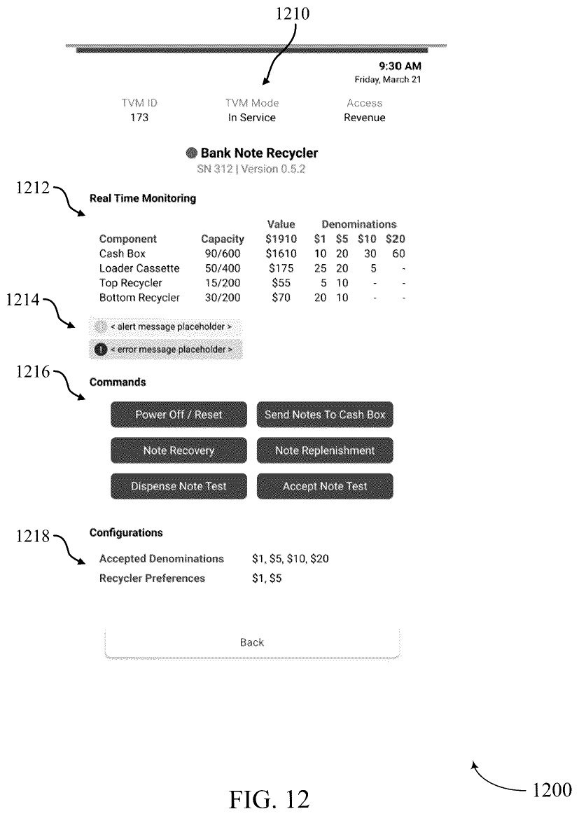

FIG. 12 illustrates an example user interface 1200 for a ticket vending machine (TVM), providing a comprehensive overview of machine status, operational controls, and configuration options. The user interface 1200 may present machine information 1210 at the top of the display, including details such as the TVM identification number, operational mode (e.g., In Service), access level (e.g., Revenue), and the current date and time. This section may also include agency branding or location-specific information to assist maintenance staff or operators in quickly verifying the identity and status of the machine.

Additionally, the user interface 1200 may provide a real time monitoring section 1212, which displays up-to-date data on key machine components involved in cash handling, such as the cash box, loader cassette, top recycler, and bottom recycler. For each component, the interface may show current capacity, total value of stored currency, and a breakdown of denominations (e.g., $1, $5, $10, $20 bills). This may allow operators to assess the cash status at a glance and make informed decisions about replenishment or collection. The interface may also display error messages 1214 or alerts, such as warnings for low capacity, jams, or hardware faults, enabling rapid troubleshooting and minimizing downtime. A set of commands 1216 may be provided, allowing authorized users to execute key actions such as powering off or resetting the machine, sending notes to the cash box, initiating note recovery, performing note replenishment, dispensing note tests, or accepting note tests. These commands streamline maintenance and operational workflows, reducing the need for manual intervention. At the bottom of the interface, configurations 1218 may be displayed, indicating the accepted denominations for cash transactions (e.g., $1, $5, $10, $20) and recycler preferences (e.g., which denominations are stored for recycling).

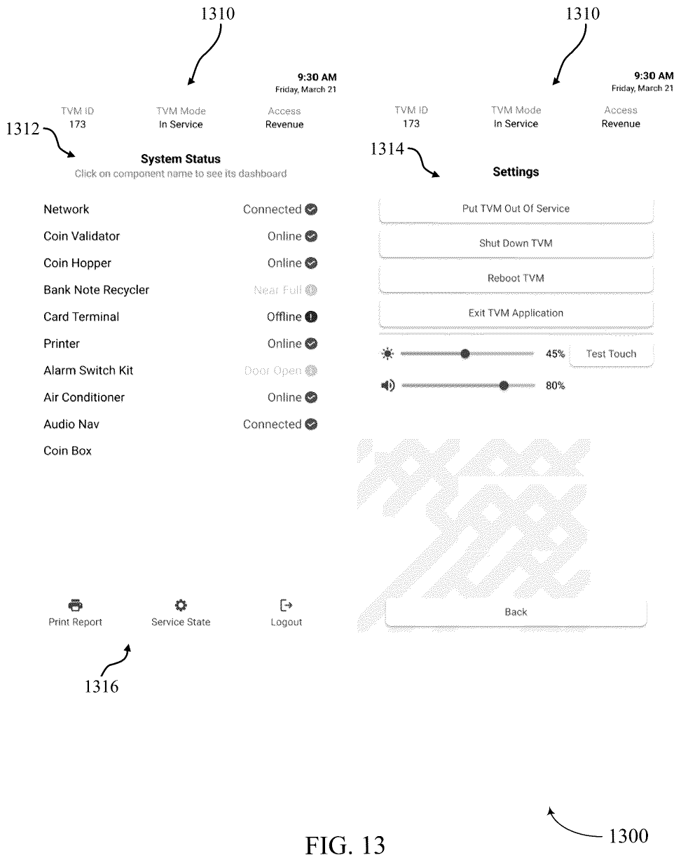

FIG. 13 illustrates an additional example user interface 1300 for a ticket vending machine (TVM). At the top of each screen, TVM information 1310 is prominently displayed, including the TVM identification number, mode (e.g., In Service), access level (e.g., Revenue), and the current date and time. This header may also include agency branding, ensuring that operators and maintenance staff can quickly verify the machine's identity and operational context during service or troubleshooting procedures. The system status section 1312 may provide a real-time overview of the health and connectivity of key machine components, such as the network, coin validator, coin hopper, bank note recycler, card terminal, printer, alarm switch kit, air conditioner, audio navigation, and coin box. Each component's status is indicated with clear visual cues (e.g., “Online,” “Connected,” “Near Full,” “Offline,” or “Door Open”), accompanied by color-coded icons to highlight issues or normal operation at a glance. This enables rapid identification of faults or maintenance needs, such as a full cash recycler or an offline card terminal. The settings section 1314 offers operational controls, allowing authorized users to put the TVM out of service, shut it down, reboot the system, or exit the TVM application. Additional settings may include adjustment of screen brightness and speaker volume, as well as interface testing tools (e.g., “Test Touch”) to verify hardware functionality. At the bottom of the interface, exporting tools 1316 provide options for printing reports, accessing service state logs, or logging out of the session, streamlining recordkeeping and compliance with operational protocols.

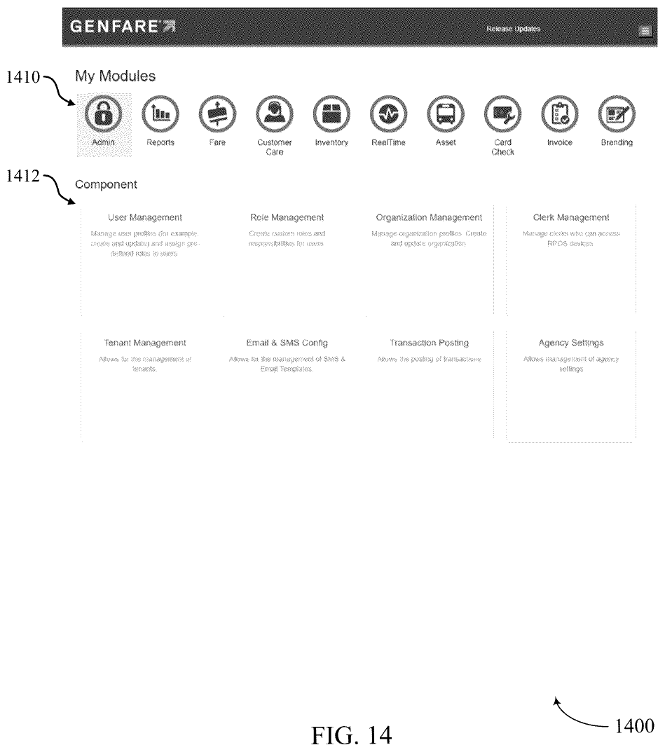

FIG. 14 illustrates an example user interface screen 1400 for a ticket vending machine (TVM) management system, providing a modular and component-based approach to administrative and operational control. The interface includes a plurality of modules 1410, which presents a series of selectable icons representing different functional modules available within the system. Example modules may include but are not limited to Admin, for user and system administration, Reports for generating and viewing operational or financial reports, Fare, for fare structure and ticketing management, Customer Care, for support and service requests, Inventory, for monitoring consumables and hardware, RealTime, for live system status and transaction monitoring, Asset, for asset tracking and maintenance, Card Check, for card validation and management, Invoice, for billing and reconciliation, and Branding, for customizing the user interface to agency specifications. Each module provides access to a dedicated set of features and workflows tailored to the operational needs of transit agencies.

The user interface screen 1400 may also include components 1412, displaying individual management and configuration options related to the selected module. For example, the User Management component enables the creation and editing of user profiles and the assignment of roles or access levels; Role Management allows for the definition of custom roles and associated permissions; Organization Management supports the configuration and updating of agency organizational profiles; and Clerk Management provides tools for managing clerk access to retail point-of-sale (RPOS) devices. Additional components may include but are not limited to Tenant Management, Email & SMS Configuration, Transaction, and Agency Settings.

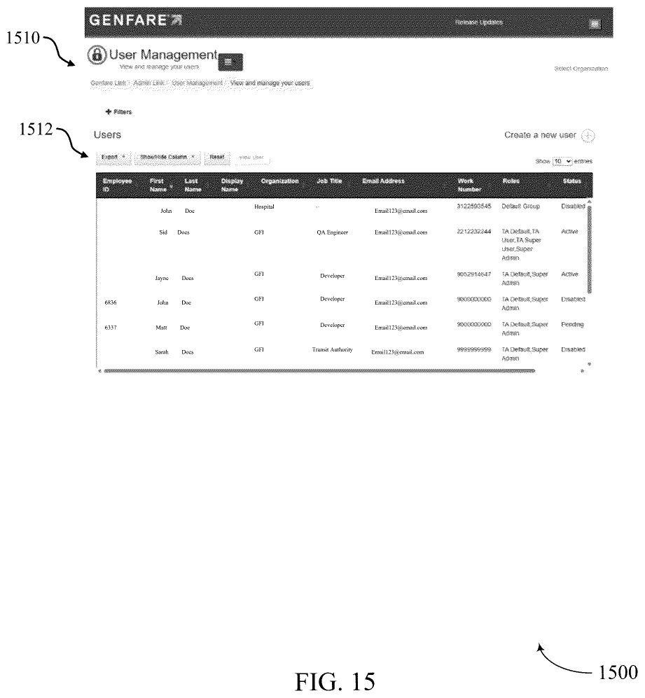

FIG. 15 illustrates an example user management interface 1500 for a ticket vending machine (TVM) management system. The user management section 1510 may provide administrators with tools to view, manage, and configure user accounts within the system. The users panel 1512 displays a searchable and sortable table of user records, including employee ID, name, organization, job title, email address, work number, assigned roles, and account status. The interface allows administrators to export user data, customize visible columns, and create or modify user accounts, supporting efficient oversight of system access, permissions, and organizational structure.

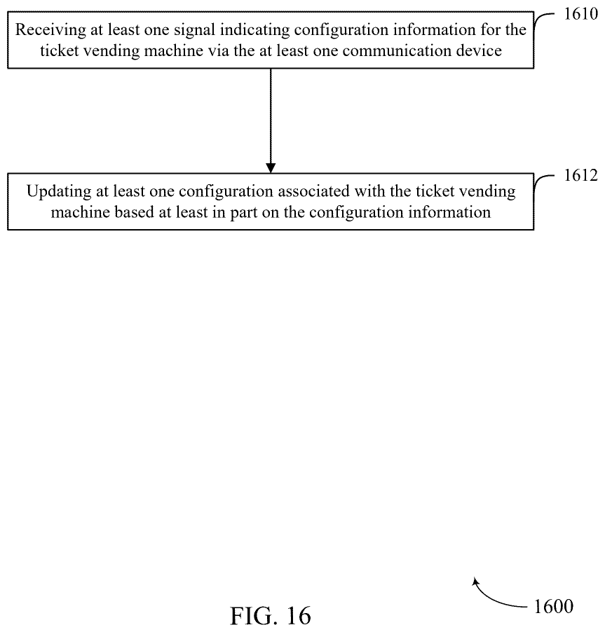

FIG. 16 is an additional flowchart of an example method 1600 for a ticket vending machine. The method 1600 may be performed by any of the example ticket vending machines described herein. At 1610, the system may receive at least one signal indicating configuration information for the ticket vending machine via the at least one communication device. In some examples, the communication device may include a wireless transceiver supporting Wi-Fi, cellular, Bluetooth, or near field communication (NFC) protocols as described herein. The configuration information may be transmitted from a remote server, a transit authority control center, or another TVM within the network, as described with respect to FIG. 1 and the connectivity manager 126.

At 1612, the system may update at least one configuration associated with the ticket vending machine based at least in part on the configuration information. The configuration update may include, but is not limited to, system configuration changes, software or firmware updates, fare adjustments, display or screen changes, updates to Internet-of-Things (IoT) devices, or system monitoring requests, as described herein. Within some examples the update may be applied automatically upon receipt of authenticated configuration information, ensuring that the TVM maintains compliance with transit policies, fare regulations, and operational requirements. Updates may be scheduled to occur at a predetermined date and time, for example, for fare changes or user interface modifications.

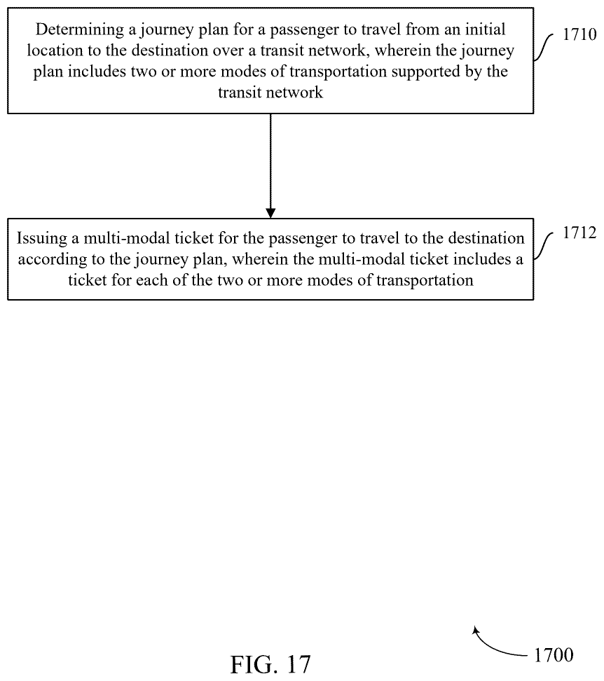

FIG. 17 is another flowchart of an example method 1700 for a ticket vending machine. The method 1700 may be performed by any of the example ticket vending machines described herein. At 1710, the system may determine a journey plan for a passenger to travel from an initial location to the destination over a transit network, wherein the journey plan may include two or more modes of transportation supported by the transit network. The TVM may receive passenger input related to a destination via a graphical user interface and, in some examples, may display alternative journey plans for user selection. The journey plan may be determined by querying the transit network and/or one or more transit vehicles for real-time information such as ridership, route status, or service disruptions. The journey plan may further account for accessibility features, including step-free routes or vehicles equipped for passengers with disabilities.

At 1712 the system may issue a multi-modal ticket for the passenger to travel to the destination according to the journey plan, wherein the multi-modal ticket includes a ticket for each of the two or more modes of transportation. In some examples, the TVM may issue the multi-modal ticket in both digital and physical formats, such as printing the ticket and/or transmitting an electronic ticket to a user device. The ticket may include journey plan details and be updated or reissued if a disruption is detected in one or more modes of transportation.

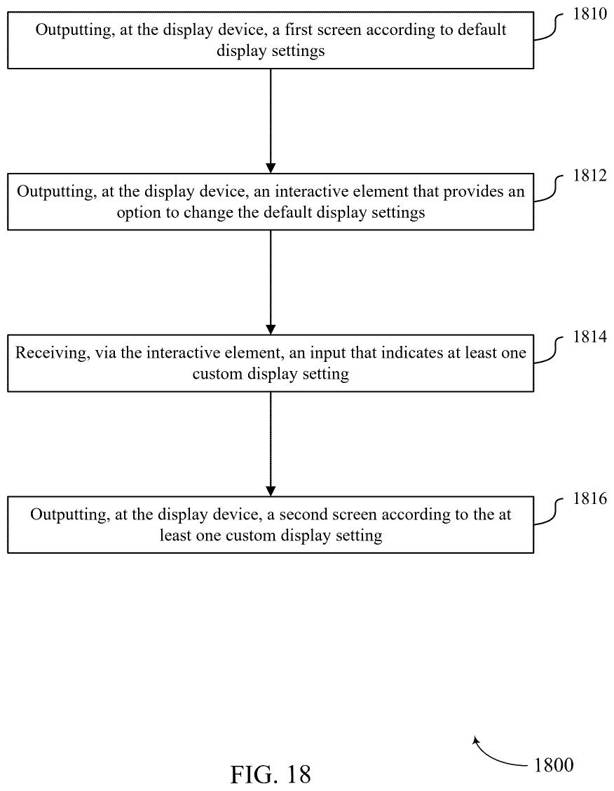

FIG. 18 is a flowchart of an example method 1800 for a ticket vending machine designed to purchase entry authorization for at least one user. The method 1800 may be performed by any of the example ticket vending machines described herein. At 1810, the system may output, at the display device, a first screen according to default display settings. The default display settings may include standard visual and interactive elements, such as default font size, color scheme, language, and layout.

At 1812, the method 1800 may output, at the display device, an interactive element that provides an option to change the default display settings. The interactive element may be presented as a settings icon, button, or menu option visible on the graphical user interface, enabling users to access customization features.

At 1814, the method 1800 may receive, via the interactive element, an input that indicates at least one custom display setting. The input may specify customizations such as increased font size, high-contrast color schemes, audio prompts, language selection, or other accessibility features. The ticket vending machine may also identify a user account associated with the custom display setting, for example, via smart card, biometric input, mobile device pairing, or personal identification number.

At 1816, the method 1800 may output, at the display device, a second screen according to the at least one custom display setting. The updated screen may immediately reflect the user's preferences, enhancing accessibility and user experience.

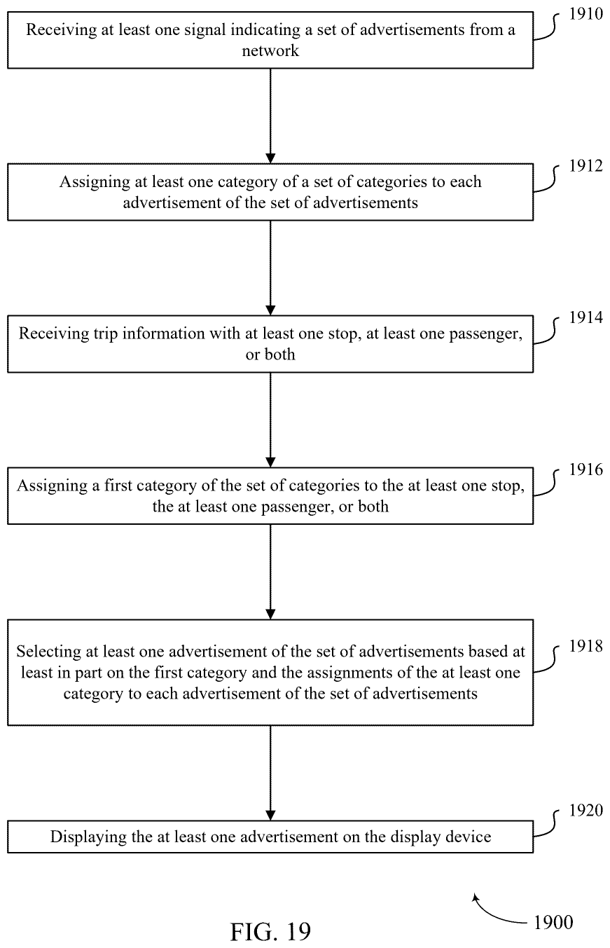

FIG. 19 is a flowchart of an example method 1900 for a ticket vending machine designed to purchase entry authorization for at least one user. The method 1900 may be performed by any of the example ticket vending machines described herein. At 1910, the method 1900 may receive at least one signal indicating a set of advertisements from a network. The TVM may be communicatively coupled to a remote server or advertising management platform, which transmits a set of advertisements over a network connection. These advertisements may be digital media, such as images, videos, or interactive content, suitable for display on the TVM's graphical user interface.

Further, at 1912, the method 1900 may assign at least one category of a set of categories to each advertisement of the set of advertisements. The system may analyze metadata or receive predefined categorizations (e.g., “family travel,” “local dining,” “business services,” “events,” etc.) for each advertisement, enabling targeted selection based on user or trip context.

At 1914, the method 1900 continues by receiving trip information with at least one stop, at least one passenger, or both. The TVM may collect data such as the passenger's selected destination, route, scheduled stops, ticket type, passenger profile, or other relevant journey details, either from direct user input or from a connected user account.

At 1916, the method 1900 may assign a first category of the set of categories to the at least one stop, the at least one passenger, or both. For example, the TVM may determine that a stop is near a shopping district (category: “shopping”), or that a passenger profile indicates a family traveler (category: “family travel”), or a commuter (category: “business”).

Further, at 1918, the method 1900 may select at least one advertisement of the set of advertisements based at least in part on the first category and the assignments of the at least one category to each advertisement of the set of advertisements. The TVM matches the assigned category of the stop or passenger to the categories of the available advertisements, selecting the most relevant or targeted ads for display.

At 1920, the method 1900 may display the at least one advertisement on the display device. The selected advertisement(s) may be presented to the user on the TVM's graphical user interface, either during the ticketing process, while the user awaits their ticket, or as part of a dynamic content rotation.

The various illustrative blocks and components described in connection with the disclosure herein may be implemented or performed using a general-purpose processor, a DSP, an Application-Specific Integrated Circuit (ASIC), a Central Processing Unit (CPU), a graphics processing unit (GPU), a neural processing unit (NPU), a Field Programmable Gate Array (FPGA) or other programmable logic device (PLD), discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by multiple processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, controllers, firmware, hardwiring, circuitry, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. As used herein, the term “non-transitory” may be interpreted not as an eternal characteristic of a state, but as a characteristic of a state that will last for a period of time. The term “non-transitory” may specifically disavow fleeting characteristics such as characteristics of a particular carrier wave or signal or other forms that exist only transitorily in any place at any time. By way of example, and not limitation, non-transitory computer-readable media may include random access memory (RAM), read-only memory (ROM), electrically programmable read-only memory (EPROM), a cache, tape, electrically erasable programmable ROM (EEPROM), flash memory, compact disk (CD) ROM or other disk or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, the software may be transmitted from a website, server, or other remote source using a wired technology such as a coaxial cable, fiber optic cable, twisted pair, digital subscriber line (DSL), universal serial bus (USB), high-definition multimedia interface (HDMI), video graphics array (VGA), digital visual interface (DVI), thunderbolt cable, power cable, ribbon cable, integrated services digital network (ISDN), or wireless technologies such as wireless fidelity (Wi-Fi), Bluetooth, cellular network, near-field communication (NFC), Zigbee, long range (LoRa), infrared (IR), radio frequency identification (RFID), light fidelity (Li-Fi), satellite, ultra-wideband (UWB), millimeter wave (mmWave), and microwave. The wired and or wireless technologies are included in the definition of computer-readable medium. Disk and disc, as used herein, include a compact disk (CD), laser disc, optical disc, digital versatile disc (DVD), floppy disk, and Blu-ray disc. Disks or discs may reproduce data magnetically or optically using lasers. Combinations of the above are also included within the scope of computer-readable media. Any functions or operations described herein as being capable of being performed by a memory may be performed by multiple memories that, individually or collectively, are capable of performing the described functions or operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

Machine learning includes one or more systems that may be adapted to generate, train, and execute one or more trained learning models, nodes, neural networks, gradient boosting algorithms, mutual information classifiers, random forest classifications, and other machine learning and artificial intelligence-based algorithms or models to process inputs, parameters, and other data elements. In some examples, the one or more trained learning models can include deep learning, machine learning, neural networks, computer vision, and similar advanced artificial intelligence-based technologies. In some examples, machine learning or artificial intelligence may use additional inputs or feedback loops to an iterative training process for enhanced data processing and improved outcomes.

Although the disclosure may describe components and functions that may be implemented in a particular example with reference to a particular standard or protocol, the disclosure is not limited to the standard or protocol. Other standards or protocols supporting similar functionality are considered equivalents thereof.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Furthermore, “and/or” as used in a list of items indicates an inclusive list such that, for example, a list of at least one of A, B, and/or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B. For example, as used herein, the phrase “based on” shall be construed in the same manner as the phrase “based at least in part on.”

As used herein, including in the claims, the article “a” before a noun may be open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The terms “determine,” “determining,” “identify,” or “identifying” encompasses a variety of actions and, therefore, “determining” or “identifying” can include calculating, computing, processing, deriving, investigating, looking up (such as via looking up in a table, a database, or another data structure), receiving, ascertaining, and the like. Also, “determining” or “identifying” can include receiving (for example, receiving information), accessing (for example, accessing data stored in memory), retrieving, and the like. Also, “determining” or “identifying” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label or other subsequent reference label.

The description set forth herein, in connection with the appended figures, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples. The features of the various examples described herein may be combined in any suitable manner. It is contemplated that one or more features from one example may be incorporated into another example unless explicitly stated otherwise. The combinations of features from different examples are within the scope of the disclosure.

It will be appreciated by those skilled in the art that while the disclosure has been described above in connection with particular examples, the disclosure is not necessarily so limited, and that numerous other examples, uses, means for, modifications and departures from the examples, uses, and means for are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A ticket vending machine, comprising
a digital touch screen designed to output a user interface, the user interface designed to support at least one of an audio control, a tactile control, or combinations thereof;
a barcode reader;
a ticket dispenser including at least one of a smart card dispenser, a paper ticket printer, a receipt printer, or combinations thereof;
a fare validation system including a credit card terminal and a currency validation system, wherein the currency validation system includes a coin validation device, a currency hopper, and a bank note recycler; and
a housing designed to house the digital touch screen, the barcode reader, the ticket dispenser, and the fare validation system.

2. The ticket vending machine of claim 1, further comprising:
at least one memory storing processor-executable code; and
at least one processor in communication with the at least one memory and individually or collectively operable to execute code to cause the ticket vending machine to:
receive input data associated with at least one user via the user interface;
identify at least one query from the input data associated with the at least one user;
output, to a transportation ticketing system, at least one signal indicating an information request related to the at least one query;
receive, from the transportation ticketing system, at least one signal indicating information related to the information request; and
output, via the user interface, at least one signal indicating an answer to at least one query based at least in part on the information.

3. The ticket vending machine of claim 1, wherein the fare validation system further comprises a contactless payment reader.

4. The ticket vending machine of claim 1, wherein the audio control includes at least one of a speaker, a microphone, or combinations thereof, and wherein the tactile control includes at least one of Braille markings, raised buttons, or combinations thereof.

5. The ticket vending machine of claim 1, wherein the paper ticket printer is designed to print advertisements, travel information, a travel itinerary, a paid fare amount, a receipt, a travel recommendation, or combinations thereof.

6. The ticket vending machine of claim 1, wherein the receipt printer is configured to print transaction summaries, payment methods, time of purchase, or a combination thereof.

7. A ticket vending machine, comprising:
a graphical user interface designed to receive passenger input related to a destination;
at least one memory storing processor-executable code; and
at least one processor in communication with the at least one memory an individually or collectively operable to execute code to cause the ticket vending machine to:
determine a journey plan for a passenger to travel from an initial location to the destination over a transit network, wherein the journey plan includes two or more modes of transportation supported by the transit network; and
issue a multi-modal ticket for the passenger to travel to the destination according to the journey plan, wherein the multi-modal ticket includes a ticket for each of the two or more modes of transportation.

8. The ticket vending machine of claim 7, further comprising:
at least one communication device designed to communicate information over a network with at least one of the transit network, at least one transit vehicle, or combinations thereof, wherein the at least one processor is further operable to execute code to cause the ticket vending machine to:
query at least one of the transit network or the at least one transit vehicle for real-time information, wherein the real-time information includes at least one of ridership information, route information, or combinations thereof, wherein the journey plan is further based at least in part on the real-time information.

9. The ticket vending machine of claim 7, further comprising:
a printing device designed to print the multi-modal ticket and information related to the journey plan.

10. The ticket vending machine of claim 7, wherein the graphical user interface is further designed to display alternative journey plans and prompt a user to select a preferred journey plan from the alternative journey plans.

11. The ticket vending machine of claim 10, wherein a journey plan accounts for accessibility features, including step-free routes, vehicles equipped for passengers with disabilities, or a combination thereof.

12. The ticket vending machine of claim 8, wherein the processor is further operable to execute the code to cause the ticket vending machine to:
detect a disruption to one or more transit vehicles associated with the journey plan; and
update the journey plan and reissue a modified multi-modal ticket based at least in part on the disruption.

13. The ticket vending machine of claim 8, wherein the at least one communication device is further configured to receive alerts regarding service outages or disruptions from the transit network.

14. A ticket vending machine designed to purchase entry authorization for at least one user, comprising:
a display device designed to output a graphical user interface;
at least one memory storing processor-executable code; and
at least one processor in communication with the at least one memory an individually or collectively operable to execute code to cause the ticket vending machine to:
output, at the display device, a first screen according to default display settings;
output, at the display device, an interactive element that provides an option to change the default display settings;
receive, via the interactive element, an input that indicates at least one custom display setting; and
output, at the display device, a second screen according to the at least one custom display setting.

15. The ticket vending machine of claim 14, wherein the at least one processor is further operable to execute the code to cause the ticket vending machine to:
revise the default display settings based at least in part on the at least one custom display setting.

16. The ticket vending machine of claim 15, wherein the at least one processor is further operable to execute the code to cause the ticket vending machine to:
identify a user account associated with the at least one custom display setting; and
store the at least one custom display setting in a user profile associated with the user account as updated default display settings, wherein the updated default display settings comprise a default display setting for the user account.

17. The ticket vending machine of claim 16, wherein the at least one processor is further operable to execute code to cause the ticket vending machine to:
retrieve updated default display settings from the user profile upon identification of the user account; and
apply the updated default display settings for the user profile.

18. The ticket vending machine of claim 16, wherein the at least one custom display setting includes at least one accessibility feature including an increased font size, high-contrast color schemes, audio prompts, a language selection, or combinations thereof.

19. The ticket vending machine of claim 16, wherein an identification of the user account is authenticated via at least one of a smart card, a biometric input, a mobile device pairing, a personal identification number, or combinations thereof.

20. The ticket vending machine of claim 16, wherein the at least one processor is further operable to execute the code to cause the ticket vending machine to:
output at least one signal indicating the updated default display settings to a remote server for synchronization with other ticket vending machines associated with the user account.
